(19) United States
(12) Patent Application Publication
(10) Pub. No.: US 2024/0205557 A1
(43) Pub. Date: Jun. 20, 2024

(54) IMAGING DEVICE, ELECTRONIC APPARATUS, AND IMAGING METHOD

(71) Applicant: Sony Semiconductor Solutions Corporation, Kanagawa (JP)

(72) Inventors: Takehiro Otani, Kanagawa (JP); Yuki Ozawa, Kanagawa (JP); Takeru Matsuki, Kanagawa (JP); Shin Kitano, Kanagawa (JP)

(21) Appl. No.: 18/555,797

(22) PCT Filed: Feb. 28, 2022
(86) PCT No.: PCT/JP2022/008143

§ 371 Date: Oct. 17, 2023

(30) Foreign Application Priority Data
Jun. 4, 2021 (JP) 2021-094735

(51) Int. Cl. H04N 25/57; H04N 25/47; H04N 25/77

(52) U.S. Cl. CPC H04N 25/57; H04N 25/47; H04N 25/77

(57) ABSTRACT

An imaging device capable of reducing erroneous detection of a luminance change is provided.

According to one embodiment of the present disclosure, there is provided an imaging device including: a photoelectric conversion element configured to generate an optical current acquired by photoelectrically converting incident light; a current-voltage conversion circuit configured to convert the optical current into a voltage signal; a threshold monitoring circuit configured to monitor the optical current; a plurality of capacitance elements including a variable capacitance element of which a capacitance value changes on the basis of a monitoring result of the threshold monitoring circuit; and an event detecting circuit configured to detect a luminance change of the incident light on the basis of a result of comparison between an amplified voltage acquired by amplifying the voltage signal on the basis of a capacitance ratio of the plurality of capacitance elements and a threshold voltage.

### TECHNICAL FIELD

The present disclosure relates to an imaging device, an electronic apparatus, and an imaging method.

### BACKGROUND ART

As one imaging device of an event-driven type, an imaging device of an asynchronous type called an event-based vision sensor (EVS) is known. In an imaging device of an asynchronous type, data of a part in which there is a change in a luminance level, which occurs in accordance with a certain event (for example, movement), is acquired only when the certain event occurs in a scene.

Thus, an imaging device of an asynchronous type can acquire image data at a higher speed than a general imaging device of a synchronous type that unnecessarily acquires all the data of an image at a fixed frame rate.

### CITATION LIST

### Patent Literature

### [PTL 1]

Japanese Translation of PCT Application No. 2018-148553

### [PTL 2]

Japanese Translation of PCT Application No. 2008-523695

### [PTL 3]

Japanese Translation of PCT Application No. 2015-501936

### SUMMARY

### Technical Problem

In the imaging device of the asynchronous type as described above, a luminance change (event) of incident light is detected on the basis of a voltage value of a voltage signal (pixel signal) generated through photoelectric conversion of the incident light. However, for example, in an imaging environment in which the luminance of incident light is low, a noise level of a voltage signal becomes high. For this reason, even when a voltage value of a voltage signal is at a level at which a luminance change is not originally detected, there are cases in which erroneous detection occurs.

The present disclosure provides an imaging device, an electronic apparatus, and a light detecting method capable of reducing erroneous detection of a luminance change.

### Solution to Problem

According to one embodiment of the present disclosure, there is provided an imaging device including: a photoelectric conversion element configured to generate an optical current acquired by photoelectrically converting incident light; a current-voltage conversion circuit configured to convert the optical current into a voltage signal; a threshold monitoring circuit configured to monitor the optical current; a plurality of capacitance elements including a variable capacitance element of which a capacitance value changes on the basis of a monitoring result of the threshold monitoring circuit; and an event detecting circuit configured to detect a luminance change of the incident light on the basis of a result of comparison between an amplified voltage acquired by amplifying the voltage signal on the basis of a capacitance ratio of the plurality of capacitance elements and a threshold voltage.

The threshold monitoring circuit may include: a current source configured to set a threshold current; a first current mirror circuit configured to replicate the optical current; and a second current mirror circuit configured to replicate the threshold current.

The plurality of capacitance elements may include a first capacitance element that is the variable capacitance element and a second capacitance element of which a capacitance value is smaller than that of the first capacitance element, a first capacitance value of the first capacitance element may decrease in a case in which the optical current is smaller than the threshold current, and the first capacitance value may increase in a case in which the optical current is equal to or larger than the threshold current.

The plurality of capacitance elements may include a first capacitance element of which a capacitance value is larger than that of a second capacitance element and the second capacitance element that is the variable capacitance element, a second capacitance value of the second capacitance element may increase in a case in which the optical current is smaller than the threshold current, and the second capacitance value may decrease in a case in which the optical current is equal to or larger than the threshold current.

The plurality of capacitance elements may include a first capacitance element that is the variable capacitance element and a second capacitance element, a first capacitance value of the first capacitance element and a second capacitance value of the second capacitance element may be changed such that a capacitance ratio between the first capacitance element and the second capacitance element becomes small in a case in which the optical current is smaller than the threshold current, and the first capacitance value and the second capacitance value may be changed such that the capacitance ratio becomes large in a case in which the optical current is equal to or larger than the threshold current.

The event detecting circuit may include a switching circuit performing switching of the threshold voltage in accordance with a result of comparison between the optical current and the threshold current.

The photoelectric conversion element, the current-voltage conversion circuit, the plurality of capacitance elements, and the event detecting circuit may be disposed inside a pixel, the first current mirror circuit and a part of the second current mirror circuit in the threshold monitoring circuit may be disposed inside the pixel, and the current source and a remaining part of the second current mirror circuit may be disposed outside the pixel.

The entire threshold monitoring circuit may be disposed in a first substrate that is the same as that of the photoelectric conversion element, the current-voltage conversion circuit, the plurality of capacitance elements, and the event detecting circuit.

Apart of the second current mirror circuit may be disposed in a first substrate that is the same as that of the photoelectric conversion element, the current-voltage conversion circuit, the plurality of capacitance elements, and the event detecting circuit, and the current source and a remaining part of the second current mirror circuit may be disposed in a second substrate stacked on the first substrate.

The photoelectric conversion element and a part of the current-voltage conversion circuit may be disposed in a first substrate, and a remaining part of the current-voltage conversion circuit, the plurality of capacitance elements, the event detecting circuit, and the threshold monitoring circuit may be disposed in a second substrate stacked on the first substrate.

The photoelectric conversion element may be disposed in a first substrate, and the current-voltage conversion circuit, the plurality of elements, the event detecting circuit, and the threshold monitoring circuit may be disposed in a second substrate stacked on the first substrate.

The first current mirror circuit may include a first MOS transistor of a P-channel type and a plurality of second MOS transistors of the P-channel type connected to the first MOS transistor of the P-channel type in parallel, the second current mirror circuit may include a plurality of first MOS transistors of an N-channel type connected to each of the plurality of second MOS transistors of the P-channel type and a second MOS transistor of the N-channel type connected to the current source in series, and the plurality of first MOS transistors of the N-channel type may have mutually different ratios of channel widths and channel lengths of gates.

The first current mirror circuit may include a first MOS transistor of a P-channel type and a plurality of second MOS transistors of the P-channel type connected to the first MOS transistors of the P-channel type in parallel, and the second current mirror circuit may include a plurality of first MOS transistors of an N-channel type connected to the plurality of second MOS transistors of the P-channel type in series and a plurality of second MOS transistors of the N-channel type connected to a plurality of current sources of which threshold currents are different from each other in series.

The variable capacitance element may include a plurality of capacitance elements connected in parallel and at least one or more switching elements connected to other capacitance elements except for one capacitance element among the plurality of capacitance elements in series, and the switching element may switch on and off in accordance with a monitoring result of the threshold monitoring circuit.

The switching element may include a third MOS transistor of the P-channel type, a third MOS transistor of the N-channel type connected to the third MOS transistors of the P-channel type in parallel, and an inverter element connected between a gate of the third MOS transistor of the P-channel type and a gate of the third MOS transistor of the N-channel type.

A pixel array unit in which a plurality of pixels are arranged in a matrix shape may be further included, and the threshold monitoring circuit may be disposed in all the pixels of the pixel array unit.

The threshold monitoring circuit may be disposed in a specific pixel in a pixel group formed from a plurality of pixels.

According to one embodiment of the present disclosure, there is provided an electronic apparatus including an imaging device including: a photoelectric conversion element configured to generate an optical current acquired by photoelectrically converting incident light; a current-voltage conversion circuit configured to convert the optical current into a voltage signal; a threshold monitoring circuit configured to monitor the optical current; a plurality of capacitance elements including a variable capacitance element of which a capacitance value changes on the basis of a monitoring result of the threshold monitoring circuit; and an event detecting circuit configured to detect a luminance change of the incident light on the basis of a result of comparison between an amplified voltage acquired by amplifying the voltage signal on the basis of a capacitance ratio of the plurality of capacitance elements and a threshold voltage.

According to one embodiment of the present disclosure, there is provided an imaging method including: generating an optical current acquired by photoelectrically converting incident light; converting the optical current into a voltage signal; monitoring the optical current; setting a capacitance value of the variable capacitance element on the basis of a monitoring result of the optical current; comparing an amplified voltage acquired by amplifying the voltage signal with a threshold voltage on the basis of a capacitance ratio of a plurality of capacitance elements including the variable capacitance element; and detecting a luminance change of the incident light on the basis of a result of comparison between the amplified voltage and the threshold voltage.

### BRIEF DESCRIPTION OF DRAWINGS

FIG. 1 is a block diagram illustrating one configuration example of an electronic apparatus in which an imaging device according to a first embodiment is mounted.

FIG. 2 is a block diagram illustrating one configuration example of an imaging device.

FIG. 3 is a block diagram illustrating one configuration example of pixels arranged in a pixel array unit.

FIG. 4 is a circuit diagram illustrating one example of the circuit configuration of a light receiving unit and a pixel signal generation unit.

FIG. 5 is a block diagram illustrating another configuration example of an imaging device.

FIG. 6 is an exploded perspective view illustrating an overview of a chip structure of the imaging device illustrated in FIG. 2 or 5.

FIG. 7 is a circuit diagram of an address event detecting unit according to the first embodiment.

FIG. 8 is a diagram illustrating one configuration example of a first capacitance element according to the first embodiment.

FIG. 9 is a diagram illustrating one configuration example of a switching element.

FIG. 10 is a flowchart illustrating a processing operation of an address event detecting unit.

FIG. 11 is a waveform diagram of a voltage Vout of an event detecting unit according to a comparative example.

FIG. 12 is a waveform diagram of a voltage Vout of an address event detecting unit according to the first embodiment.

FIG. 13 is a circuit diagram of an address event detecting unit of an imaging device according to a second embodiment.

FIG. 14 is a circuit diagram of an address event detecting unit of an imaging device according to a third embodiment.

FIG. 15 is a circuit diagram of an address event detecting unit of an imaging device according to a fourth embodiment.

FIG. 16 is a circuit diagram illustrating a configuration of an event detecting circuit according to the fourth embodiment.

FIG. 17 is a circuit diagram illustrating one configuration example of a first switching circuit and a second switching circuit.

FIG. 18 is a diagram illustrating voltage levels of threshold voltages of an event detecting circuit.

FIG. 19 is a circuit diagram of a major part of an address event detecting unit of an imaging device according to a fifth embodiment.

FIG. 20 is a diagram illustrating a first modified example of a chip layout.

FIG. 21 is a diagram illustrating a second modified example of a chip layout.

FIG. 22 is a diagram illustrating a third modified example of a chip layout.

FIG. 23 is a circuit diagram of a major part of an address event detecting unit of an imaging device according to a sixth embodiment.

FIG. 24 is a diagram illustrating one configuration example of a first capacitance element according to the sixth embodiment.

FIG. 25 is a circuit diagram of a major part of an address event detecting unit of an imaging device according to a seventh embodiment.

FIG. 26 is a diagram illustrating an arrangement form of a threshold monitoring circuit and a threshold variable circuit.

FIG. 27 is a diagram illustrating another arrangement form of a threshold monitoring circuit and a threshold variable circuit.

FIG. 28 is a block diagram illustrating an exemplary schematic configuration of a vehicle control system.

FIG. 29 is an explanatory diagram showing an example of installation positions of an external vehicle information detecting unit and an imaging unit.

### DESCRIPTION OF EMBODIMENTS

Hereinafter, embodiments of an imaging device and an imaging method will be described with reference to the drawings. Hereinafter, while main components of the imaging device will be mainly described, the imaging device may have components or functions that are not illustrated or described. The following description does not exclude components or functions that are not illustrated or described.

### First Embodiment

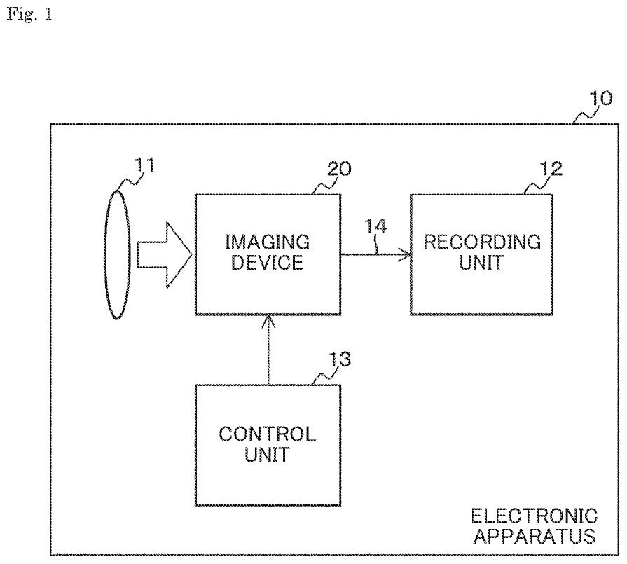

FIG. 1 is a block diagram illustrating one configuration example of an electronic apparatus in which an imaging device according to a first embodiment is mounted.

The electronic apparatus 10 illustrated in FIG. 1 includes an imaging lens 11, an imaging device 20, a recording unit 12, and a control unit 13. For example, this electronic apparatus 10 can be applied to a camera system mounted in an industrial robot, an in-vehicle camera system, and the like.

The imaging lens 11 takes in incident light from a subject and forms an image on an imaging face of the imaging device 20. The imaging device 20 photoelectrically converts incident light taken in by the imaging lens 11 in units of pixels, thereby acquiring captured data.

The imaging device 20 performs predetermined signal processing such as an image recognizing process and the like for captured image data and outputs a processing result thereof and data representing a detection signal of an address event to be described below (which may hereinafter be simply referred to as “detection signal”) to the recording unit 12. A method of generating a detection signal of an address event will be described below. The recording unit 12 stores data supplied from the imaging device 20 through a signal line 14. The control unit 13, for example, is configured using a microcomputer and performs control of an imaging operation of the imaging device 20.

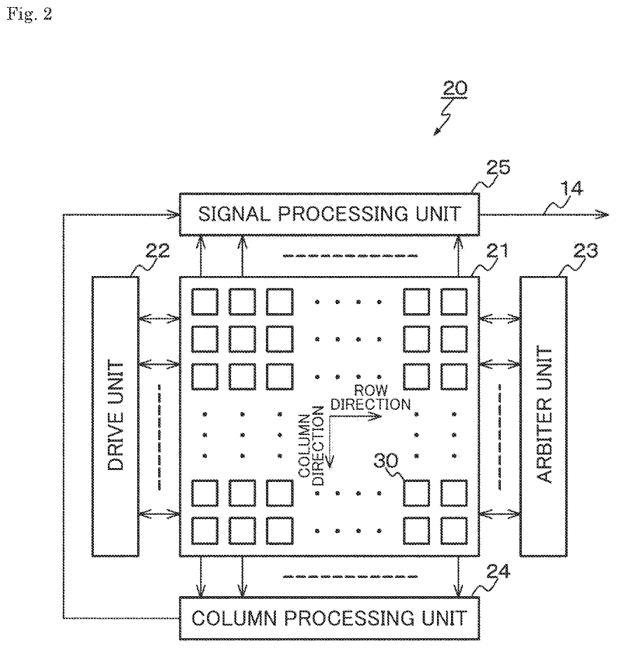

FIG. 2 is a block diagram illustrating one configuration example of the imaging device 20. The imaging device 20 illustrated in FIG. 2 is an imaging device of an asynchronous device called an event-based vision sensor (EVS) and includes a pixel array unit 21, a drive unit 22, an arbiter unit (adjustment unit) 23, a column processing unit 24, and a signal processing unit 25.

In the pixel array unit 21, a plurality of pixels 30 are two-dimensionally arranged in a matrix shape (array shape). For a pixel array of this matrix shape, for each pixel column, a vertical signal line VSL to be described below is wired.

Each pixel 30 generates an analog signal of a voltage corresponding to an optical current I_{PD} acquired by photoelectrically converting incident light as a pixel signal. In addition, each pixel 30 detects presence/absence of an address event on the basis of whether or not an amount of change of the optical current I_{PD} exceeds a predetermined threshold. Then, when an address event occurs, the pixel 30 outputs a request to the arbiter unit 23.

The drive unit 22 drives each pixel 30 and outputs a pixel signal generated by each pixel 30 to the column processing unit 24.

The arbiter unit 23 adjusts a request from each pixel 30 and transmits a response based on a result of the adjustment to the pixel 30. The pixel 30 that has received the response from the arbiter unit 23 supplies a detection signal (a detection signal of an address event) representing the detection result to the drive unit 22 and the signal processing unit 25. The reading of a detection signal from each pixel 30 may be performed using multiple-row reading.

The column processing unit 24, for example, has an analog-to-digital converter (ADC) and, for each pixel column of the pixel array unit 21, converts analog pixel signals output from the pixels 30 of the column into digital signals. Subsequently, the column processing unit 24 supplies these digital signals to the signal processing unit 25.

The signal processing unit 25 performs predetermined signal processing such as a Correlated Double Sampling (CDS) process, an image recognizing process, and the like for a digital signal supplied from the column processing unit 24. Subsequently, the signal processing unit 25 supplies data representing a process result and a detection signal supplied from the arbiter unit 23 to the recording unit 12 (see FIG. 1) through the signal line 14.

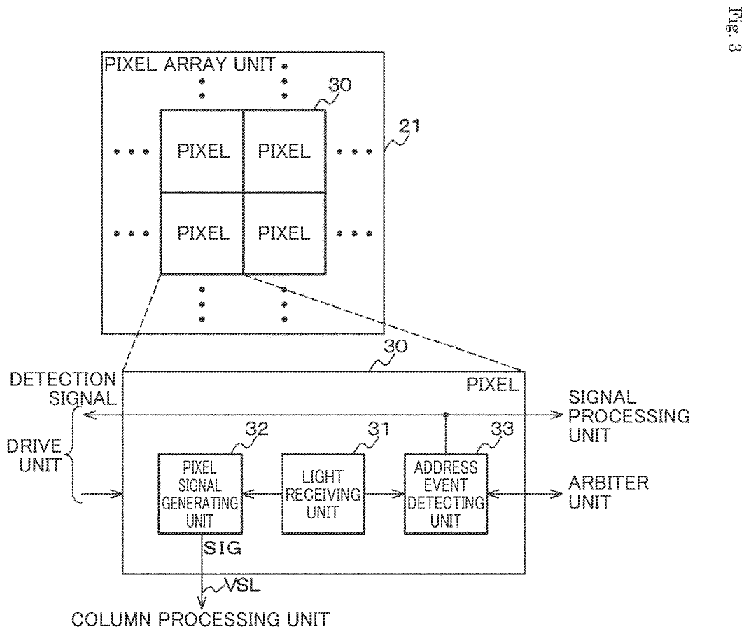

FIG. 3 is a block diagram illustrating one configuration example of the pixels 30 arranged in the pixel array unit 21. Each pixel 30 illustrated in FIG. 3 includes a light receiving unit 31, a pixel signal generation unit 32, and an address event detecting unit 33.

The light receiving unit 31 generates an optical current I_{PD} by photoelectrically converting incident light. Subsequently, the light receiving unit 31 supplies the optical current I_{PD} to one of the pixel signal generation unit 32, the address event detecting unit 33 on the basis of control of the drive unit 22 (see FIG. 2).

The pixel signal generation unit 32 generates a pixel signal SIG corresponding to an optical current I_{PD} supplied from the light receiving unit 31 and supplies this pixel signal SIG to the column processing unit 24 (see FIG. 2) through the vertical signal line VSL.

The address event detecting unit 33 detects presence/absence of an address event depending on whether or not an amount of change of the optical current I_{PD} from each light receiving unit 31 has exceeded a predetermined threshold. The address event, for example, has an on-event indicating that the amount of change of the optical current I_{PD} has exceeded an upper limit threshold and an off-event indicating that the amount of change thereof has been below a lower limit threshold. In addition, a detection signal of an address event, for example, has one bit representing a detection result of an on-event and one bit representing a detection result of an off event. In addition, the address event detecting unit 33 may be configured to detect only an on-event.

When an address event occurs, the address event detecting unit 33 supplies a request for requesting transmission of a detection signal of an address event to the arbiter unit 23 (see FIG. 2). Then, when a response to a request is received from the arbiter unit 23, the address event detecting unit 33 supplies a detection signal of an address event to the drive unit 22 and the signal processing unit 25.

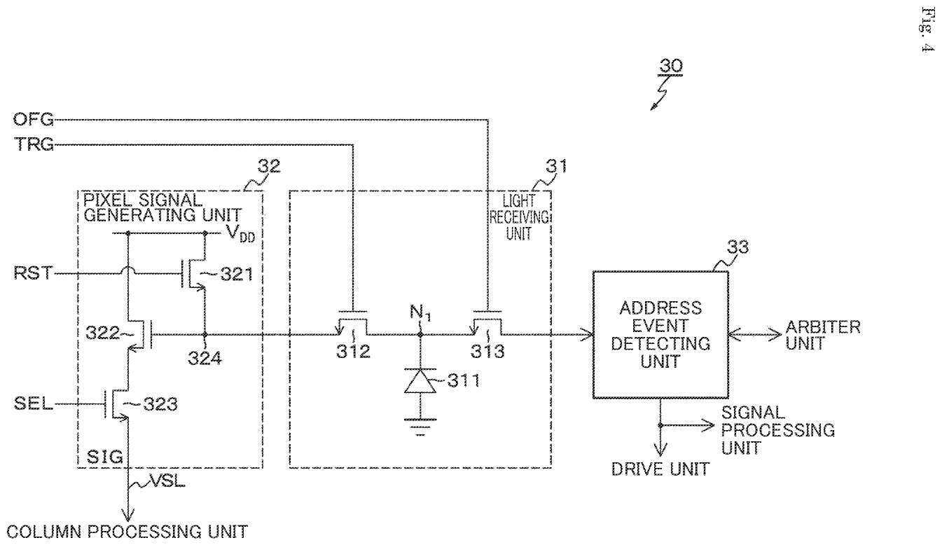

FIG. 4 is a circuit diagram illustrating one example of the circuit configuration of the light receiving unit 31 and the pixel signal generation unit 32. The light receiving unit 31 includes a photoelectric conversion element 311, a transfer transistor 312, and an Over Flow Gate (OFG) transistor 313. As the transfer transistor 312 and the OFG transistor 313, for example, Metal Oxide Semiconductor (MOS) transistors of an N-channel type are used. The transfer transistor 312 and the OFG transistor 313 are connected to each other in series.

The photoelectric conversion element 311 is connected between a common connection node N₁ between the transfer transistor 312 and the OFG transistor 313 and the ground and generates electric charge of an electric charge amount corresponding to a light quantity of incident light by performing photoelectric conversion of the incident light. The photoelectric conversion element 311, for example, is configured using a photodiode.

A transmission signal TRG is supplied to a gate electrode of the transfer transistor 312 from the drive unit 22 (see FIG. 2). In response to the transmission signal TRG, the transfer transistor 312 supplies electric charge that has been photoelectrically converted by the photoelectric conversion element 311 to the pixel signal generation unit 32.

A control signal OFG is supplied from the drive unit 22 to a gate electrode of the OFG transistor 313. In response to the control signal OFG, the OFG transistor 313 supplies an electric signal generated by the photoelectric conversion element 311 to the address event detecting unit 33. The electric signal supplied to the address event detecting unit 33 is an optical current I_{PD} formed from electric charge.

The pixel signal generation unit 32 includes a reset transistor 321, an amplification transistor 322, a selection transistor 323, and a floating diffusion layer 324. As the reset transistor 321, the amplification transistor 322, and the selection transistor 323, for example, MOS transistors of an N-channel type are used.

Electric charge photoelectrically converted by the photoelectric conversion element 311 is supplied by the transfer transistor 312 from the light receiving unit 31 to the pixel signal generation unit 32. The electric charge supplied from the light receiving unit 31 is accumulated in the floating diffusion layer 324. The floating diffusion layer 324 generates a voltage signal of a voltage value corresponding to an amount of accumulated electric charge. In other words, the floating diffusion layer 324 converts the electric charge into a voltage.

The reset transistor 321 is connected between a power supply line of a power supply voltage V_{DD} and the floating diffusion layer 324. A reset signal RST is supplied from the drive unit 22 to a gate electrode of the reset transistor 321. In response to the reset signal RST, the reset transistor 321 initializes (resets) the amount of electric charge of the floating diffusion layer 324.

The amplification transistor 322 is connected to the selection transistor 323 in series between the power supply line of the power supply voltage V_{DD} and the vertical signal line VSL. The amplification transistor 322 amplifies a voltage signal that has been converted from electric charge into a voltage by the floating diffusion layer 324.

A selection signal SEL is supplied from the drive unit 22 to a gate electrode of the selection transistor 323. In response to the selection signal SEL, the selection transistor 323 outputs a voltage signal amplified by the amplification transistor 322 to the column processing unit 24 (see FIG. 2) through the vertical signal line VSL as a pixel signal SIG.

In the imaging device 20 configured as described above, when the control unit 13 illustrated in FIG. 1 instructs the drive unit 22 to start detection of an address event, the drive unit 22 supplies a control signal OFG to the OFG transistor 313 of the light receiving unit 31. In accordance with this, the OFG transistor 313 is driven, and an optical current I_{PD} is supplied to the address event detecting unit 33.

Thereafter, when an address event is detected in a certain pixel 30, the drive unit 22 sets the OFG transistor 313 of the pixel 30 to an off state, thereby stopping supply of the optical current I_{PD} to the address event detecting unit 33. Next, by supplying a transmission signal TRG to the transfer transistor 312, the drive unit 22 drives this transfer transistor 312, thereby transmitting electric charge photoelectrically converted by the photoelectric conversion element 311 to the floating diffusion layer 324.

In this way, the imaging device 20 outputs only a pixel signal of the pixel 30 in which an address event has been detected to the column processing unit 24. In accordance with this, compared to a case in which pixel signals of all the pixels are output regardless of presence/absence of an address event, power consumption and a processing amount of image processing of the imaging device 20 can be reduced.

In addition, the configuration of the pixel 30 described above is one example and is not limited to this configuration example. For example, a pixel configuration not including the pixel signal generation unit 32 may be employed. In the case of this pixel configuration, the OFG transistor 313 may be omitted in the light receiving unit 31, and the transfer transistor 312 may have the function of this OFG transistor 313.

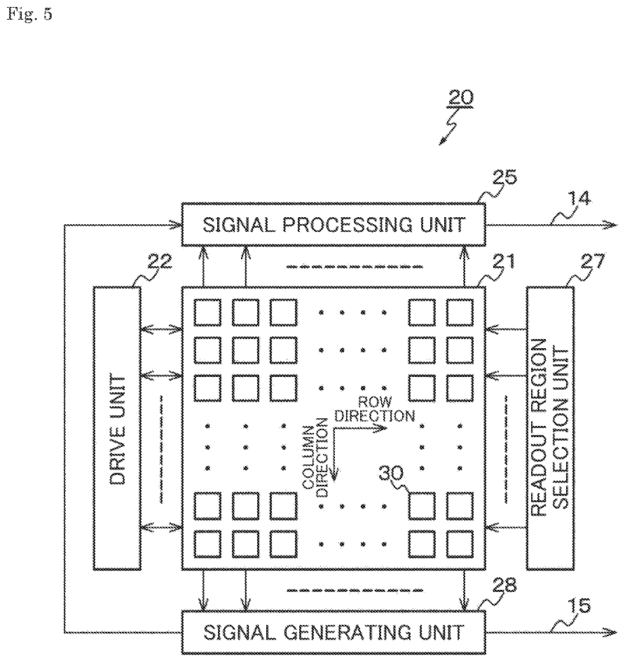

FIG. 5 is a block diagram illustrating another configuration example of the imaging device 20. The imaging device 20 illustrated in FIG. 5 is an imaging device of a scanning type and includes a pixel array unit 21, a drive unit 22, a signal processing unit 25, a readout region selection unit 27, and a signal generation unit 28.

The pixel array unit 21 includes a plurality of pixels 30 that are two-dimensionally arranged in a matrix shape. In response to a selection signal of the readout region selection unit 27, each pixel 30 outputs an output signal. Each pixel 30 may have a configuration that includes a quantization circuit inside the pixel. Each pixel 30 outputs an output signal corresponding to an amount of change of the intensity of light.

The drive unit 22 drives each pixel 30 and causes a pixel signal generated by each pixel 30 to be output to the signal processing unit 25. In addition, the drive unit 22 and the signal processing unit 25 are circuit units used for acquiring grayscale information. Thus, in a case in which only event information is acquired, the drive unit 22 and the signal processing unit 25 may not be provided.

The readout region selection unit 27 selects some of the plurality of pixels 30 included in the pixel array unit 21. For example, the readout region selection unit 27 selects any one or a plurality of rows included in a structure of a two-dimensional matrix corresponding to the pixel array unit 21. The readout region selection unit 27 sequentially selects one or a plurality of rows according to a preset cycle. Further, the readout region selection unit 27 may determine a selection area in response to a request from each pixel 30 of the pixel array unit 21.

The signal generation unit 28 generates an event signal corresponding to an active pixel that has detected an event among the selected pixels, on the basis of the output signal of the pixel selected by the readout region selection unit 27. The event is an event in which the intensity of light changes. The active pixel is a pixel in which an amount of change of the intensity of light corresponding to an output signal exceeds or falls below a threshold set in advance. For example, the signal generation unit 28 compares the output signal of the pixel with a reference signal, detects an active pixel that outputs the output signal when the output signal is larger or smaller than the reference signal, and generates an event signal corresponding to the active pixel.

The signal generation unit 28 can be configured to include, for example, a column selection circuit for arbitrating a signal input to the signal generation unit 28. Further, the signal generation unit 28 can be configured to output not only information on the active pixel that has detected an event but also information on an inactive pixel that has not detected an event.

From the signal generation unit 28, address information and time stamp information (for example, (X,Y,T)) of an active pixel in which an event has been detected is output through an output line 15. Here, data output from the signal generation unit 28 may be not only the address information and the time stamp information but also information of a frame form (for example, (0, 0, 1, 0, . . . )).

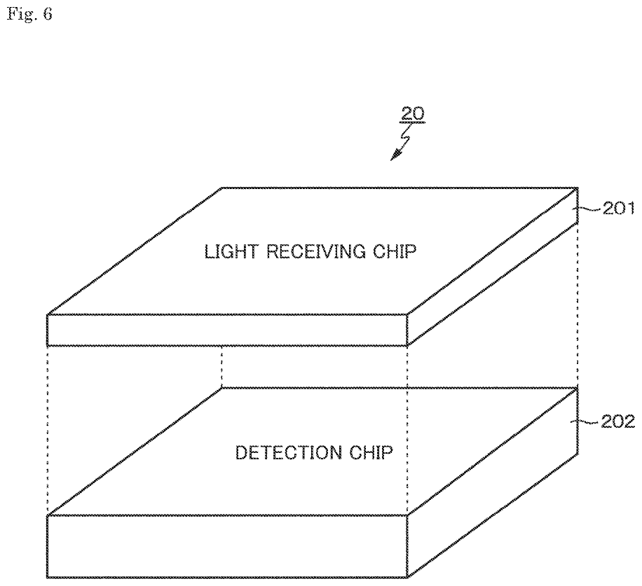

FIG. 6 is an exploded perspective view illustrating an overview of a chip structure of the imaging device 20 illustrated in FIG. 2 or 5. As illustrated in FIG. 6, the imaging device 20 has a stacking structure in which at least two chips including a light receiving chip 201 corresponding to a first substrate and a detection chip 202 corresponding to a second substrate are stacked. For example, the photoelectric conversion element 311 in the pixel 30 illustrated in FIG. 4 is disposed on the light receiving chip 201, and all the elements other than the photoelectric conversion element 311 and elements and the like of other circuit parts of the pixel 30 are disposed on the detection chip 202. The light receiving chip 201 and the detection chip 202 are electrically connected to each other through a connection part such as a via, Cu—Cu bonding, a bump, or the like. In other words, the light receiving chip 201 and the detection chip 202 are bonded together using any one of a Chip on Chip (CoC) system, a Chip on Wafer (CoW) system, or a Wafer on Wafer (WoW) system. In addition, this embodiment is not limited to the layout in which the photoelectric conversion element 311 is disposed in the light receiving chip 201, and elements other than the photoelectric conversion element 311, and elements and the like of circuit parts other than the pixel 30 are disposed in the detection chip 202.

For example, each element of the light receiving unit 31 may be disposed in the light receiving chip 201, and elements other than the light receiving unit 31 and elements and the like of other circuit parts of the pixel 30 may be disposed in the detection chip 202. In addition, each element of the light receiving unit 31, the reset transistor 321 of the pixel signal generation unit 32, and the floating diffusion layer 324 may be disposed in the light receiving chip 201, and the other elements may be disposed in the detection chip 202. Furthermore, some of elements configuring the address event detecting unit 33 may be disposed in the light receiving chip 201 together with each element of the light receiving unit 31 and the like.

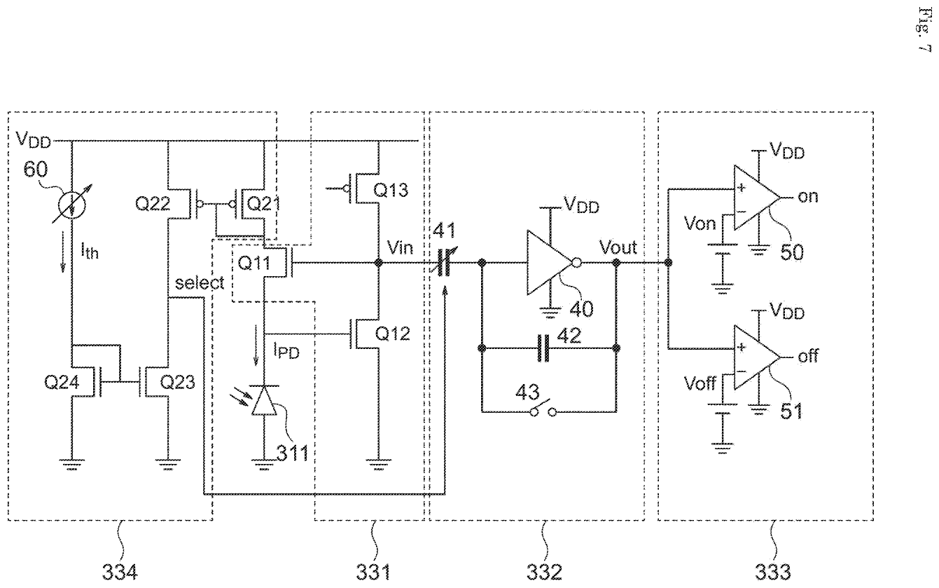

FIG. 7 is a circuit diagram of the address event detecting unit 33 according to the first embodiment. The address event detecting unit 33 includes a current-voltage conversion circuit 331, a subtraction circuit 332, an event detecting circuit 333, and a threshold monitoring circuit 334. Hereinafter, the configuration of each circuit will be described.

The current-voltage conversion circuit 331 includes MOS transistors Q11 and Q12 of an N-channel type and a MOS transistor Q13 of a P-channel type. In the MOS transistor Q11 of the N-channel type, a source is connected to a cathode of the photoelectric conversion element 311, a drain is connected to the power supply voltage node V_{DD} through the transistor Q121 of the P-channel type of the threshold monitoring circuit 334, and a gate is connected to one end of the first capacitance element 41 of the subtraction circuit 332. The MOS transistor Q12 of the N-channel type and the MOS transistor Q13 of the P-channel type are cascade-connected between the power supply voltage node V_{DD} and a ground node. A gate of the MOS transistor Q12 of the N-channel type is connected to the cathode of the photoelectric conversion element 311.

The MOS transistors Q11 and Q12 of the N-channel type configure a source follower. In addition, the MOS transistor of the N-channel type and the MOS transistor Q13 of the P-channel type configure a source follower. In accordance with these two source followers connected in a loop shape, an optical current I_{PD} flowing through the photoelectric conversion element 311 is converted into a voltage signal of a logarithm thereof. In addition, an amplification circuit (not illustrated) amplifying this voltage signal may be disposed between the current-voltage conversion circuit 331 and the subtraction circuit 332.

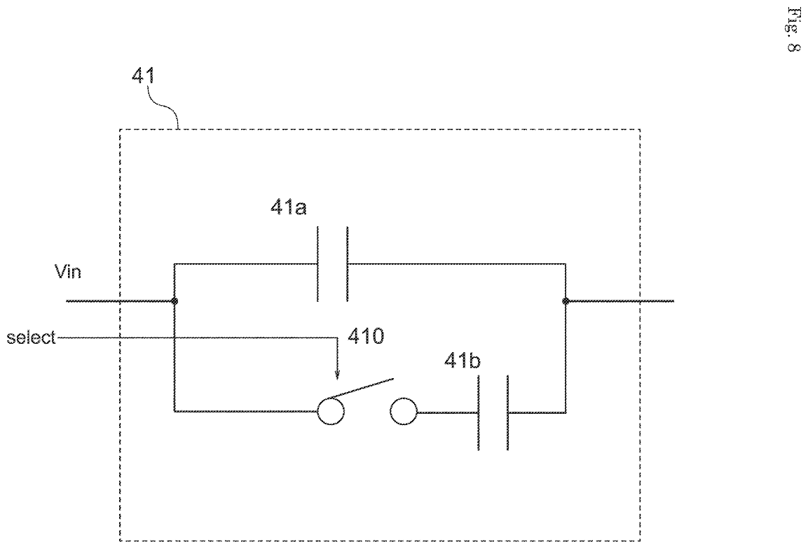

The subtraction circuit 332 includes an operational amplifier 40, a first capacitance element 41, a second capacitance element 42, and a switching element 43. One end of the first capacitance element 41 is connected to an output terminal of the current-voltage conversion circuit 331, that is, a common connection node between the drain of the MOS transistor Q13 of the P-channel type and the drain of the MOS transistor Q12 of the N-channel type. The other end of the first capacitance element 41 is connected to an input terminal of the operational amplifier 40. In accordance with this, a voltage signal supplied from the current-voltage conversion circuit 331 is input to the input terminal of the operational amplifier 40 through the first capacitance element 41. In this embodiment, the first capacitance element 41 is a variable capacitance element of which a capacitance value C1 changes. Here, the configuration of the first capacitance element 41 will be described with reference to FIG. 8.

FIG. 8 is a diagram illustrating one configuration example of the first capacitance element 41 according to the first embodiment. The first capacitance element 41 illustrated in FIG. 8 includes a capacitance element 41a, a capacitance element 41b, and a switching element 410. The capacitance element 41a and the capacitance element 41b are connected in parallel with each other. The switching element 410 is connected to the capacitance element 41b in series.

The switching element 410 switches on and off in accordance with a level of a select signal representing a monitoring result of the threshold monitoring circuit 334. When the select signal is in a high level, the switching element 410 becomes on. For this reason, a capacitance value C1 of the first capacitance element 41 becomes an added value of a capacitance value C1_1 of the capacitance element 41a and a capacitance value C1_2 of the capacitance element 41b. On the other hand, when the select signal is in a low level, the switching element 410 becomes off. For this reason, the capacitance value C1 of the first capacitance element 41 becomes the capacitance value C1_1 of the capacitance element 41a. In other words, when the select signal changes to the high level, the capacitance value C1 of the first capacitance element 41 increases, and, when the select signal changes to the low level, the capacitance value C1 of the first capacitance element 41 decreases.

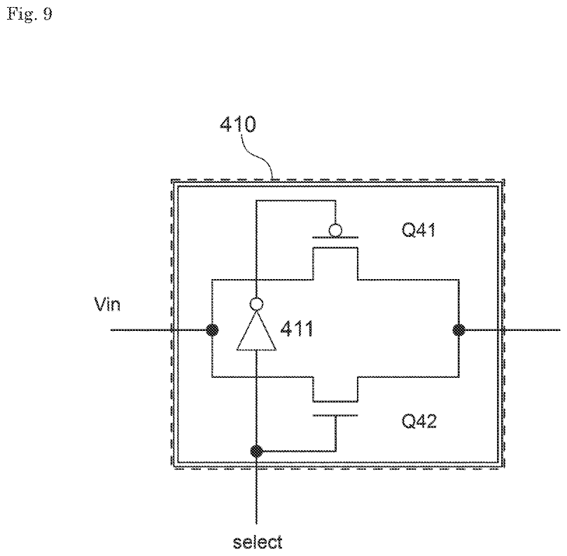

FIG. 9 is a diagram illustrating one configuration example of the switching element 410. The switching element 410 illustrated in FIG. 9 includes a MOS transistor Q41 of the P-channel type, a MOS transistor Q42 of the N-channel type, and an inverter element 411. The MOS transistor Q41 of the P-channel type and the MOS transistor Q42 of the N-channel type have a Complementary Metal Oxide Semiconductor (CMOS) configuration in which they are connected in parallel. The inverter element 411 is connected between the gate of the MOS transistor Q41 of the P-channel type and the gate of the MOS transistor Q42 of the N-channel type.

In a case in which the switching element 410 has the CMOS configuration as illustrated in FIG. 9, on-resistance is reduced, and the linearity of a signal waveform is improved. In addition, the switching element 410 is not limited to the CMOS configuration and may be configured using only one of the MOS transistor Q41 of the P-channel type or the MOS transistor Q42 of the N-channel type.

Referring back to FIG. 7, the second capacitance element 42 is connected to the first capacitance element 41 in series and is connected to the operational amplifier 40 in parallel. The switching element 43 is connected between both ends of the second capacitance element 42. A reset signal is supplied to the switching element 43 from the arbiter unit 23 (see FIG. 2). The switching element 43 opens or doses a path connecting both the ends of the second capacitance element 42 in accordance with the reset signal.

In the subtraction circuit 332 configured as described above, in a case in which the switching element 43 becomes on, when an optical voltage Vin1 is input to one end of the first capacitance element 41, the other end of the first capacitance element 41 becomes a virtual ground terminal. For the convenience of description, an electric potential of this virtual ground terminal is assumed to be zero. At this time, electric charge Q1 accumulated in the first capacitance element 41 can be represented using the following Equation (1) using the optical voltage Vin1 and the capacitance value C1 of the first capacitance element 41.

$$Q 1 = C 1 \times Vin 1 \qquad ( 1 )$$

In addition, when the switching element 43 becomes on, both ends of the second capacitance element 42 form a short circuit, and thus the amount of electric charge accumulated in the second capacitance element 42 becomes zero.

Thereafter, an optical voltage of one end of the first capacitance element 41 at the time of the switching element 43 being off will be denoted as Vin2. Electric charge Q2 accumulated in the first capacitance element 41 at the time of switching element 43 being off can be represented using the following Equation (2).

$$Q 2 = C 1 \times Vin 2 \qquad ( 2 )$$

When the capacitance value of the second capacitance element 42 is denoted as C2, and an output voltage of the operational amplifier 40 is denoted as Vout, electric charge Q3 accumulated in the second capacitance element 42 can be represented using the following Equation (3).

$$Q 3 = - C 2 \times Vout \qquad ( 3 )$$

Before and after the switching element 43 becomes off, a total amount of electric charge acquired by adding the amount of electric charge of the first capacitance element 41 and the amount of electric charge of the second capacitance element 42 does not change, and thus the following Equation (4) is satisfied.

$$Q 1 = Q 2 - Q 3 \qquad ( 4 )$$

When Equation (1) to Equation (3) are substituted into Equation (4), the following Equation (5) can be acquired.

$$Vout = - ( C 1 / C 2 ) \times ( Vin 2 - Vin 1 ) \qquad ( 5 )$$

According to Equation (5), the subtraction circuit 332 performs subtraction between the optical voltage Vin1 and the optical voltage Vin2, that is, calculation of a difference signal corresponding to a difference between the optical voltage Vin1 and the optical voltage Vin2. In addition, according to Equation (5), the voltage Vout becomes an amplified voltage acquired by amplifying a difference between the optical voltages with a capacitance ratio C1/C2 between the first capacitance value C1 of the first capacitance element 41 and the second capacitance value C2 of the second capacitance element 42 as its gain.

Generally, since it is preferable to maximize the gain of subtraction of the subtraction circuit 332, the capacitance value C1 of the first capacitance element 41 is larger than the second capacitance value C2 of the second capacitance element 42.

The event detecting circuit 333 includes a first comparator 50 and a second comparator 51. The first comparator 50 compares the voltage Vout of the output signal of the subtraction circuit 332 with the lower limit threshold voltage Von set in advance. Subsequently, the first comparator 50 outputs an event signal on representing whether or not the voltage Vout is equal to or lower than the lower limit threshold voltage Von.

On the other hand, the second comparator 51 compares the voltage Vout described above with the upper limit threshold voltage Voff set in advance. Subsequently, the second comparator 51 outputs an event signal off representing whether or not the voltage Vout is equal to or higher than the upper limit threshold voltage Voff. In this way, the event detecting circuit 333 detects an event (a luminance change of incident light) on the basis of a result of comparison between the voltage Vout and the lower limit threshold voltage Von and the upper limit threshold voltage Voff.

The threshold monitoring circuit 334 includes MOS transistors Q21 and Q22 of the P-channel type, the MOS transistors Q23 and Q24 of the N-channel type, and a current source (a reference current source) 60.

The MOS transistors Q21 and Q22 of the P-channel type configure a first current mirror circuit. The first current mirror circuit causes a current acquired by replicating an optical current I_{PD} flowing through the photoelectric conversion element 311 to flow between the source and the drain of the MOS transistor Q22 of the P-channel type. The MOS transistor Q22 of the P-channel type and the MOS transistor Q23 of the N-channel type are cascade connected between the power supply voltage node V_{DD} and the ground node.

On the other hand, the MOS transistors Q23 and Q24 of the N-channel type configure a second current mirror circuit. In addition, the current source 60 is connected to the drain of the MOS transistor Q24 of the N-channel type. The second current mirror circuit replicates a threshold current Iₜₕ set by the current source 60. In accordance with this, a select signal representing a result of comparison between the optical current I_{PD} replicated by the first current mirror circuit and the threshold current Iₜₕ replicated by the second current mirror circuit is output from the drain of the MOS transistor Q23 of the N-channel type. For example, in a case in which I_{PD}≤Iₜₕ, the select signal becomes the low level. To the contrary, in a case in which I_{PD}>Iₜₕ, the select signal becomes the high level.

The current source 60 sets the threshold current Iₜₕ. In this embodiment, the current source 60 is a variable current source in which an arbitrary threshold current Iₜₕ can be set. In addition, the current source 60 and the MOS transistor Q24 of the N-channel type configure a current control circuit that controls the threshold current Iₜₕ.

Hereinafter, a process operation of the address event detecting unit 33 configured as described above will be described.

FIG. 10 is a flowchart illustrating a process operation of the address event detecting unit 33. While a power supply voltage is supplied to the imaging device 20, the address event detecting unit 33 repeatedly performs the process illustrated in FIG. 10.

First, the threshold monitoring circuit 334 monitors the optical current I_{PD} flowing through the photoelectric conversion element 311 (Step S11). Next, the threshold monitoring circuit 334 compares the optical current I_{PD} with the threshold current Iₜₕ (Step S12).

When I_{PD}>Iₜₕ, the select signal becomes the high level, and thus the switching element 410 of the first capacitance element 41 becomes on (Step S13). As a result, the capacitance value C1 of the first capacitance element 41 increases, and thus a capacitance ratio (C1/C2) between the first capacitance element 41 and the second capacitance element 42, that is, a gain of the voltage Vout becomes large.

On the other hand, when I_{PD}≤Iₜₕ, the select signal becomes the low level, and thus the switching element 410 of the first capacitance element 41 becomes off (Step S14). As a result, the capacitance value C1 of the first capacitance element 41 decreases, and thus the capacitance ratio described above (the gain of the voltage Vout) becomes small.

In parallel with the processes of Steps S11 to S14, when the optical current I_{PD} changes (Step S15), the event detecting circuit 333 detects a voltage change amount of the voltage Vout corresponding to the optical current I_{PD} (Step S16).

Subsequently, the event detecting circuit 333 compares the voltage Vout with the lower limit threshold voltage Von and the upper limit threshold voltage Voff (Step S17).

In a case in which the voltage Vout is equal to or lower than the lower limit threshold voltage Von or is equal to or higher than the upper limit threshold Voff, the event detecting circuit 333 outputs the event signal on or the event signal off representing an occurrence of an event (Step S18). On the other hand, in a case in which the voltage Vout is in a range from the lower limit threshold voltage Von to the upper limit threshold Voff, the event detecting circuit 333 outputs the event signal on or the event signal off representing absence of an event (Step S19).

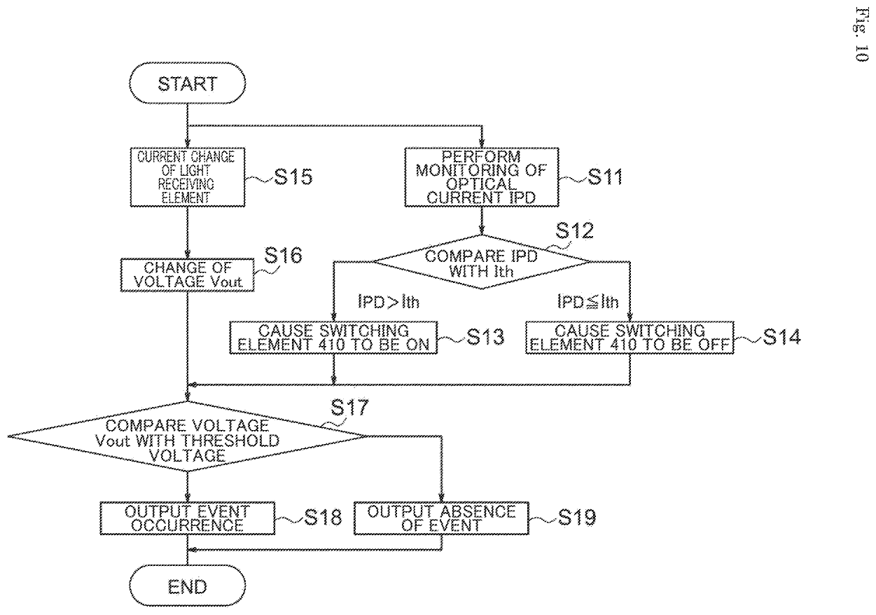

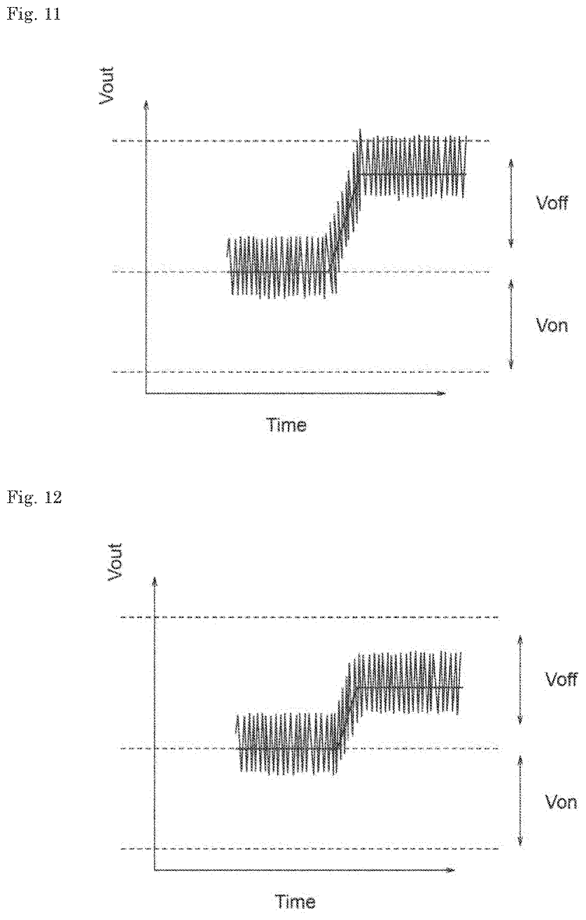

FIG. 11 is a waveform diagram of a voltage Vout of an event detecting unit according to a comparative example. In addition, FIG. 12 is a waveform diagram of the voltage Vout of the address event detecting unit 33 according to the first embodiment. In the event detecting unit according to the comparative example, both a capacitance value C1 of a first capacitance element 41 and a second capacitance value C2 of a second capacitance element 42 are fixed.

When the event detecting unit according to the comparative example detects an event under a dark-time environment in which the luminance of incident light is low, the noise of the voltage Vout becomes large. For this reason, as illustrated in FIG. 11, there are cases in which an event is erroneously detected in spite of a luminance change of a level in which no event is detected.

On the other hand, according to this embodiment, the capacitance value C1 of the first capacitance element 41 can be changed in accordance with the optical current I_{PD} corresponding to the luminance of incident light. For this reason, in the case of being under a dark-time environment, the capacitance value C1 decreases. In accordance with this, the gain (C1/C2) of the voltage Vout becomes small, and thus the voltage Vout becomes small as well. As a result, when the voltage Vout is compared with the lower limit threshold voltage Von and the upper limit threshold value Voff, it becomes difficult for an influence of noise to be received, and thus erroneous detection of event detection can be avoided.

In addition, in this embodiment, in the case of being under a bright-time environment in which the luminance of incident light is high, the capacitance value C1 increases. In accordance with this, the gain of the voltage Vout becomes large, and thus an event detection level can be improved.

Furthermore, in this embodiment, the capacitance value C1 of the first capacitance element 41 is adjusted by monitoring the optical current I_{PD} for each pixel 30. For this reason, an event detection condition that is optimal for an imaging environment can be set for each single pixel in real time.

### Second Embodiment

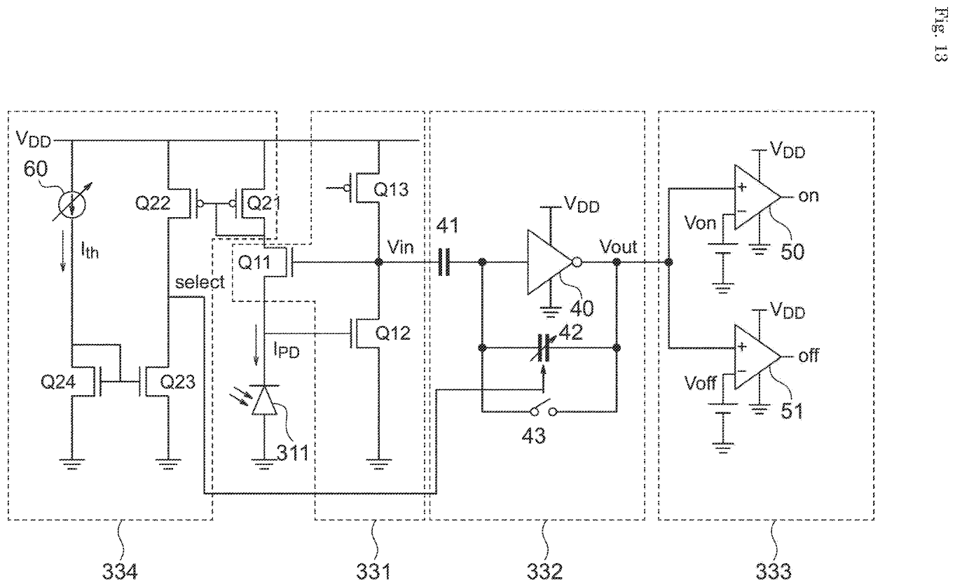

FIG. 13 is a circuit diagram of an event detecting unit of an imaging device according to a second embodiment. The same reference signs will be assigned to constituent elements that are similar to those of the address event detecting unit 33 (see FIG. 7) according to the first embodiment, and detailed description thereof will be omitted.

In this embodiment, a capacitance value C1 of a first capacitance element 41 is fixed, and a second capacitance value C2 of a second capacitance element 42 is variable. The second capacitance value C2 changes in correspondence with a level of a select signal of a threshold monitoring circuit 334.

More specifically, in a case in which the select signal is in the high level, the second capacitance value C2 decreases. In this case, similar to the first embodiment, a gain (C1/C2) of a voltage Vout becomes large. To the contrary, in a case in which the select signal is in the low level, the second capacitance value C2 increases. Also in this case, similar to the first embodiment, the gain (C1/C2) of the voltage Vout becomes small.

According to this embodiment described above, the second capacitance element 42 is a variable capacitance element of which the second capacitance value C2 changes in accordance with a select signal. For this reason, in the case of being under a dark-time environment, when the second capacitance value C2 is increased in accordance with a select signal, the gain (C1/C2) of the voltage Vout becomes small, and the voltage Vout becomes small as well. As a result, similar to the first embodiment, erroneous detection of event detection can be avoided.

In addition, in the case of being under a bright-time environment, when the second capacitance value C2 is decreased, the gain of the voltage Vout becomes large, and an event detection level can be improved.

Furthermore, in this embodiment, for each pixel 30, the optical current I_{PD} is monitored, and the second capacitance value C2 of the second capacitance element 42 is adjusted. For this reason, an event detection condition that is optimal to the imaging environment can be set in each single pixel in real time.

### Third Embodiment

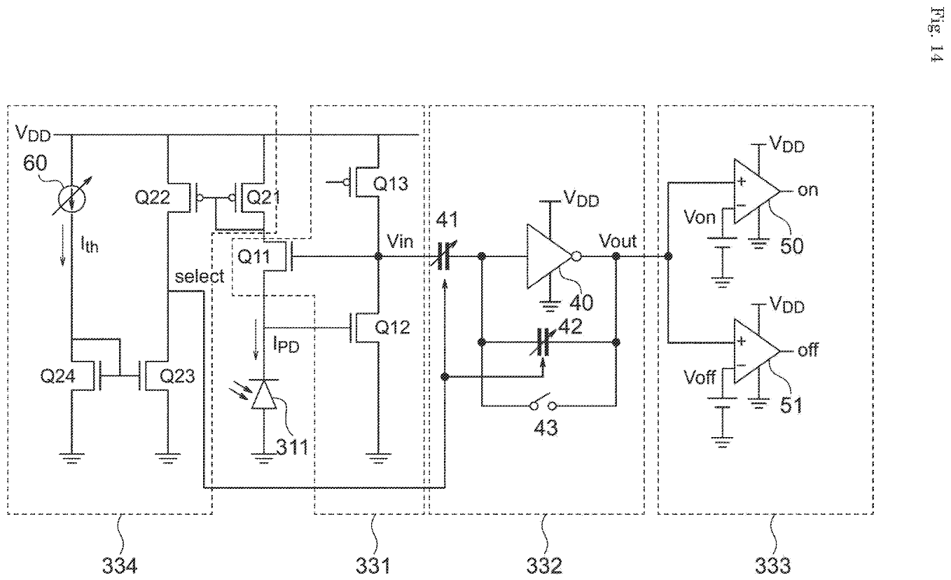

FIG. 14 is a circuit diagram of an event detecting unit of an imaging device according to a third embodiment. The same reference signs will be assigned to constituent elements that are similar to those of the address event detecting unit 33 (see FIG. 7) according to the first embodiment, and detailed description thereof will be omitted.

In this embodiment, both a first capacitance element 41 and a second capacitance element 42 are variable capacitance elements. Both a capacitance value C1 of the first capacitance element 41 and a second capacitance value C2 of the second capacitance element 42 change in accordance with a level of a select signal of a threshold monitoring circuit 334.

More specifically, in a case in which the select signal is in the high level, the capacitance value C1 and the second capacitance value C2 change such that the gain (C1/C2) of a voltage Vout becomes large. To the contrary, in a case in which the select signal is in the high level, the capacitance value C1 and the second capacitance value C2 change such that the gain (C1/C2) of the voltage Vout becomes small.

According to this embodiment described above, both the first capacitance element 41 and the second capacitance element 42 are variable capacitance elements.

For this reason, in the case of being under a dark-time environment, in accordance with a select signal of the low level, for example, when the capacitance value C1 is decreased, and the second capacitance value C2 is increased, the gain of the voltage Vout becomes small, and thus the voltage Vout becomes small as well. As a result, similar to the first embodiment, erroneous detection of event detection can be avoided.

In addition, in the case of being under a bright-time environment, in accordance with the select signal of the high level, for example, when the capacitance value C1 is increased, and the second capacitance value C2 is decreased, the gain of the voltage Vout becomes large, and thus the event detection level can be improved.

In addition, in this embodiment, for each pixel 30, the optical current I_{PD} is monitored, and the capacitance value C1 of the first capacitance element 41 and the second capacitance value C2 of the second capacitance element 42 are adjusted. Particularly, in this embodiment, the two capacitance values are variable, and thus an adjustment width of the gain of the voltage Vout becomes large. For this reason, an event detection condition that is more optimal to the imaging environment can be set in each single pixel in real time.

### Fourth Embodiment

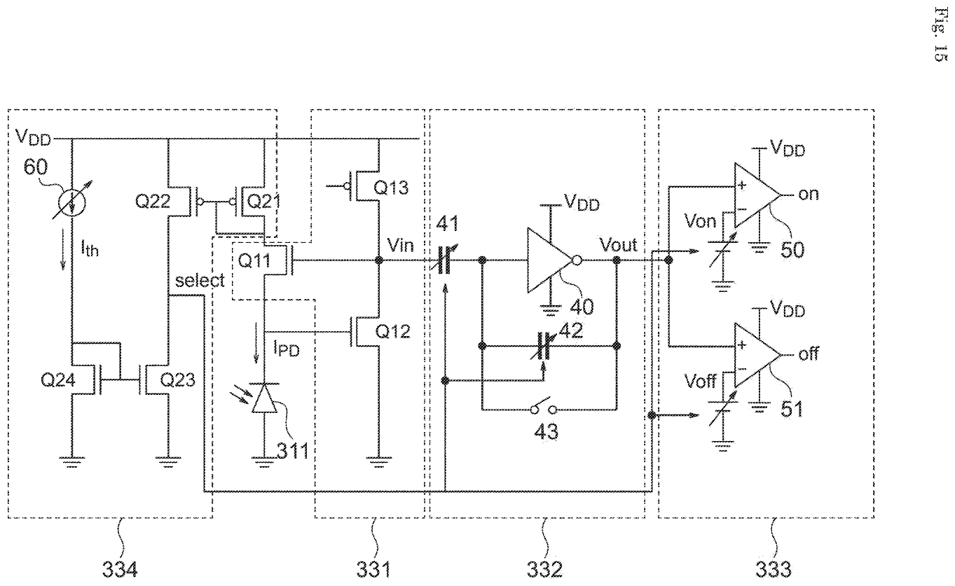

FIG. 15 is a circuit diagram of an event detecting unit of an imaging device according to a fourth embodiment. The same reference signs will be assigned to constituent elements that are similar to those of the address event detecting unit 33 (see FIG. 7) according to the first embodiment, and detailed description thereof will be omitted.

In this embodiment, both a first capacitance element 41 and a second capacitance element 42 are variable capacitance elements, and a lower limit threshold voltage Von and an upper limit threshold Voff of an event detecting circuit 333 are variable. Similar to the capacitance value C1 of the first capacitance element 41 and the second capacitance value C2 of the second capacitance element 42, also the lower limit threshold voltage Von and the upper limit threshold Voff change in accordance with the level of a select signal of a threshold monitoring circuit 334.

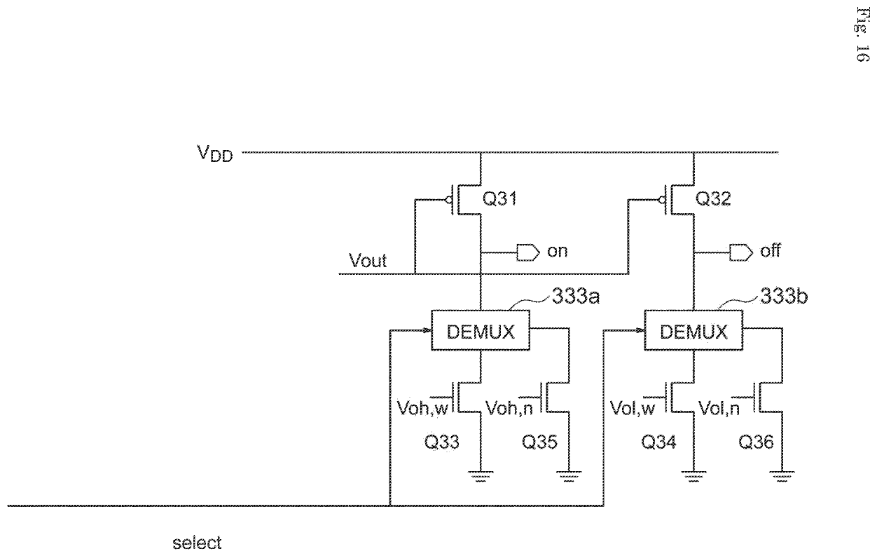

FIG. 16 is a circuit diagram illustrating a configuration of the event detecting circuit 333 according to the fourth embodiment. This event detecting circuit 333 includes MOS transistors Q31 and Q32 of the P-channel type, MOS transistors Q33, Q34, Q35, and Q36 of the N-channel type, a first switching circuit (DEMUX) 333a, and a second switching circuit (DEMUX) 333b.

Gates of the MOS transistors Q31 and Q32 of the P-channel type are connected to an output terminal of an operational amplifier 40 of a subtraction circuit 332, and a voltage thereof is Vout. The MOS transistor Q31 of the P-channel type and the MOS transistors Q33 and Q35 of the N-channel type are cascade connected between a power supply voltage node V_{DD} and a ground node through a first switching circuit 333a. The MOS transistors Q33 and Q35 of the N-channel type are connected in parallel with each other.

The MOS transistor Q32 of the P-channel type and the MOS transistors Q34 and Q36 of the N-channel type are cascade connected between the power supply voltage node V_{DD} and the ground node through a second switching circuit 333b. The MOS transistors Q34 and Q36 of the N-channel type are connected in parallel with each other.

A drain of the MOS transistor Q31 of the P-channel type is connected to an on output node that outputs an event signal on. A drain of the MOS transistor Q32 of the P-channel type is connected to an off output node that outputs an event signal off.

A voltage Voh,w is input to a gate of the MOS transistor Q33 of the N-channel type. A voltage Vol,w is input to a gate of the MOS transistor Q34 of the N-channel type. A voltage Voh,n is input to a gate of the MOS transistor Q35 of the N-channel type. A voltage Vol,n is input to a gate of the MOS transistor Q36 of the N-channel type. The voltages Voh,w Vol,w, Voh,n and Vol,n are fixed voltages, and the MOS transistors Q33, Q34, Q35, and Q36 of the N-channel type function as current sources.

In a case in which the select signal of a threshold monitoring circuit 334 is in the high level, the first switching circuit 333a connects the MOS transistor Q33 of the N-channel type to an output current path of the MOS transistor Q31 of the P-channel type. To the contrary, in a case in which the select signal is in the low level, the first switching circuit 333a connects the MOS transistor Q35 of the N-channel type to the output current path of the MOS transistor Q31 of the P-channel type.

In a case in which the select signal of the threshold monitoring circuit 334 is in the high level, the second switching circuit 333b connects the MOS transistor Q34 of the N-channel type to an output current path of the MOS transistor Q32 of the P-channel type. To the contrary, in a case in which the select signal is in the low level, the second switching circuit 333b connects the MOS transistor Q36 of the N-channel type to the output current path of the MOS transistor Q31 of the P-channel type.

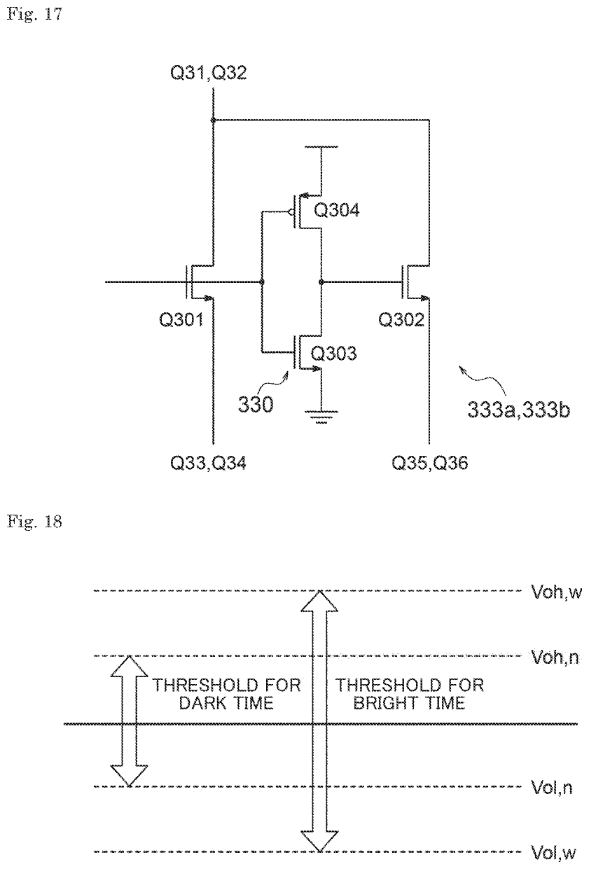

FIG. 17 is a circuit diagram illustrating one configuration example of the first switching circuit 333a and the second switching circuit 333b. The circuit configurations of the first switching circuit 333a and the second switching circuit 333b are the same, and thus the first switching circuit 333a will be taken as an example in description.

The first switching circuit 333a illustrated in FIG. 17 includes MOS transistors Q301, Q302, and Q303 of the N-channel type and a MOS transistor Q304 of the P-channel type. The MOS transistor Q301 of the N-channel type is connected between a drain of the MOS transistor Q31 of the P-channel type and a drain of the MOS transistor Q33 of the N-channel type. The MOS transistor Q302 of the N-channel type is connected between the drain of the MOS transistor Q31 of the P-channel type and a drain of the MOS transistor Q35 of the N-channel type.

The MOS transistor Q303 of the N-channel type and the MOS transistor Q304 of the P-channel type are cascade connected between the power supply voltage node VDD and the ground node and configures an inverter circuit 330.

A select signal is input to the gate of the MOS transistor Q301 of the N-channel type. The select signal is inverted by the inverter circuit 330 and then is input to the gate of the MOS transistor Q302 of the N-channel type.

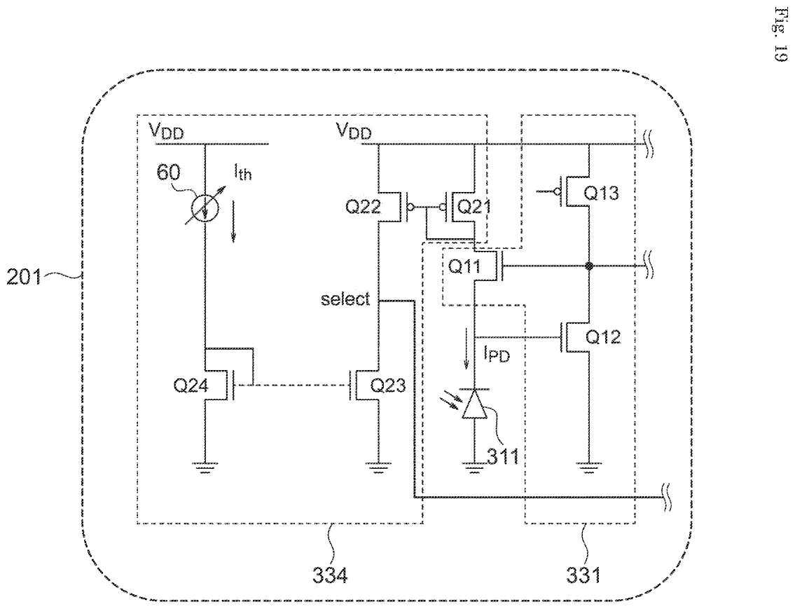

FIG. 18 is a diagram illustrating voltage levels of threshold voltages Voh,w, Vol,w, Voh,n, and Vol,n of the event detecting circuit 333. As illustrated in FIG. 18, a voltage width (threshold width) of the threshold voltages Voh,w and Vol,w selected in a case in which an optical current I_{PD} flowing through a photoelectric conversion element 311 exceeds a threshold current Iₜₕ is larger than a voltage width (threshold width) of the threshold voltages Voh,n and Vol,n selected in a case in which the optical current I_{PD} is within the threshold current Iₜₕ. By configuring the threshold width at a dark time to be narrower than the threshold width at a bright time, detection of an event at the dark time can be performed at a high speed.

In this embodiment, when I_{PD}>Iₜₕ, the select signal becomes the high level. At this time, the first switching circuit 333a and the second switching circuit 333b select the threshold voltages Voh,w and Vol,w used at the bright time. On the other hand, when I_{PD}≤Iₜₕ, the select signal becomes the low level. At this time, the first switching circuit 333a and the second switching circuit 333b select the threshold voltages Voh,n and Vol,n used at the dark time.

According to this embodiment described above, in accordance with the optical current I_{PD} flowing through the photoelectric conversion element 311, not only the capacitance value C1 of the first capacitance element 41 and the second capacitance value C2 of the second capacitance element 42 but also threshold voltages of a first comparator 50 and a second comparator 51 inside the event detecting circuit 333 change. For this reason, erroneous detection of event detection under a dark-time environment is avoided, and event detection can be performed at a high speed. In addition, in this embodiment, although both the first capacitance element 41 and the second capacitance element 42 are variable capacitance elements, any one thereof may be configured to be a variable capacitance element.

### Fifth Embodiment

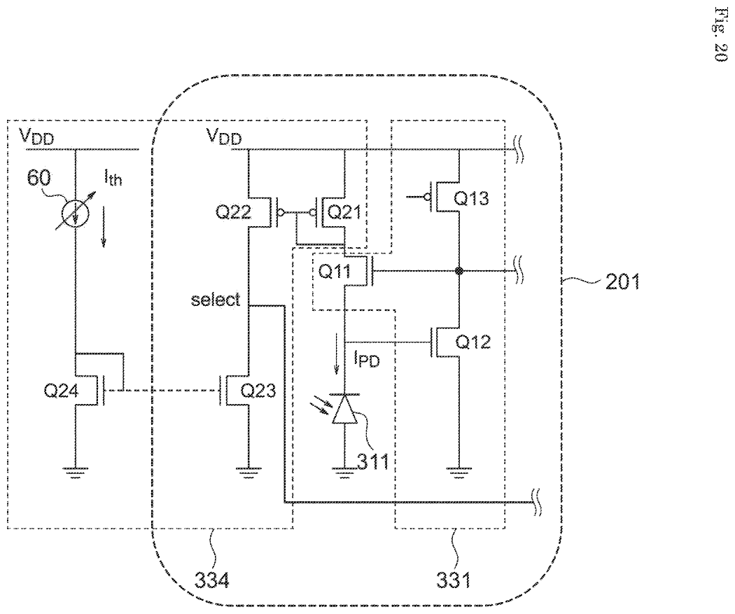

FIG. 19 is a circuit diagram of a major part of an event detecting unit of an imaging device according to a fifth embodiment. The same reference signs will be assigned to constituent elements that are similar to those of the address event detecting unit 33 (see FIG. 7) according to the first embodiment, and detailed description thereof will be omitted.

In the first to fourth embodiments described above, all the elements of the threshold monitoring circuit 334 are disposed inside one pixel 30 together with the photoelectric conversion element 311, the current-voltage conversion circuit 331, the subtraction circuit 332, and the event detecting circuit 333. On the other hand, in this embodiment, a current source 60 and a MOS transistor Q24 of the N-channel type configuring a current control circuit in a threshold monitoring circuit 334 are disposed outside a pixel 30. For this reason, a threshold current Iₜₕ set by the current source 60 is distributed to each pixel 30 by a plurality of MOS transistors Q23 of the N-channel type configuring a second current mirror circuit together with a MOS transistor Q24 of the N-channel type.

In a threshold monitoring circuit 334 of each pixel 30, similar to the other embodiments described above, a threshold current Iₜₕ is compared with an optical current I_{PD}, and a select signal representing a result of the comparison is input to at least one of a first capacitance element 41, a second capacitance element 42, and an event detecting circuit 333. In a case in which the select signal is input to the first capacitance element 41 or the second capacitance element 42, a capacitance value of each capacitance element changes in accordance with a level of the select signal. In a case in which the select signal is input to the event detecting circuit 333, a lower limit threshold voltage Von of a first comparator 50 and an upper limit threshold voltage Voff of a second comparator 51 change in accordance with the level of the select signal.

In addition, in this embodiment, although some (a current source 60 and a MOS transistor Q24 of the N-channel type) of the threshold monitoring circuit 334 are disposed outside the pixel 30, the entire threshold monitoring circuit 334 is disposed in a same light receiving chip 201 (see FIG. 6) as that of the photoelectric conversion element 311, the current-voltage conversion circuit 331, the subtraction circuit 332, and the event detecting circuit 333. For this reason, for example, the flexibility of design of the detection chip 202 for a capacitance ratio is improved. In addition, the chip layout is not limited to the example illustrated in FIG. 19.

FIG. 20 is a diagram illustrating a first modified example of the chip layout. In this modified example, the MOS transistors Q21 and Q22 of the P-channel type and the MOS transistor Q23 of the N-channel type of the threshold monitoring circuit 334 are disposed in a light receiving chip 201. In addition, the current source 60 and the MOS transistor Q24 of the N-channel type are disposed in a detection chip 202. In other words, the threshold monitoring circuit 334 is arranged to be distributed to the light receiving chip 201 and the detection chip 202.

According to the chip layout illustrated in FIG. 20, an area in which the current source 60 and the MOS transistor Q24 of the N-channel type are arranged in the light receiving chip 201 is vacant as a space. For this reason, the light receiving area of the photoelectric conversion element 311 can be widened.

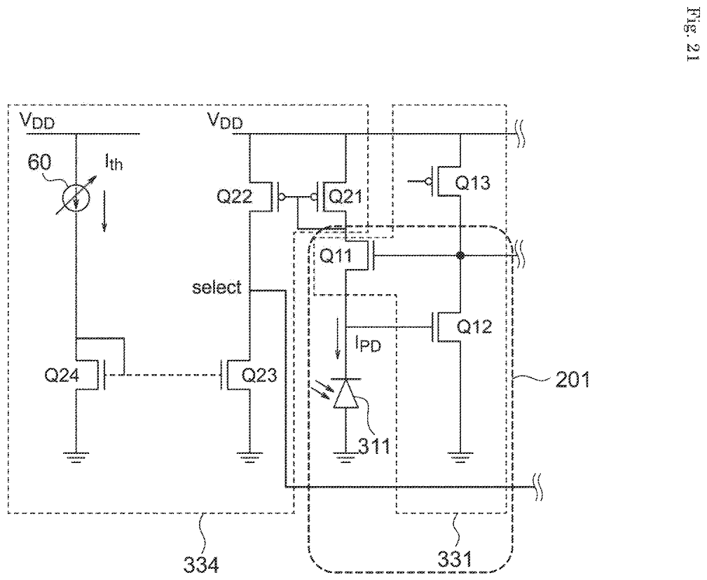

FIG. 21 is a diagram illustrating a second modified example of the chip layout. In this modified example, the MOS transistors Q11 and Q12 of the N-channel type of the current-voltage conversion circuit 331 are disposed in the same light receiving chip 201 as that of the photoelectric conversion element 311. In addition, the MOS transistor Q13 of the P-channel type of the current-voltage conversion circuit 331 are disposed in the same detection chip 202 as that of the threshold monitoring circuit 334.

According to the chip layout illustrated in FIG. 21, the space of the light receiving chip 201 is larger than that of the first modified example, and thus, the light receiving area of the photoelectric conversion element 311 can be further widened. In addition, only the MOS transistors Q11 and Q12 of the N channel type of which conduction types are the same are disposed in the light receiving chip 201, and thus design relating to electric characteristics such as a threshold voltage between the gate and the source of the transistor and the like can be easily performed.

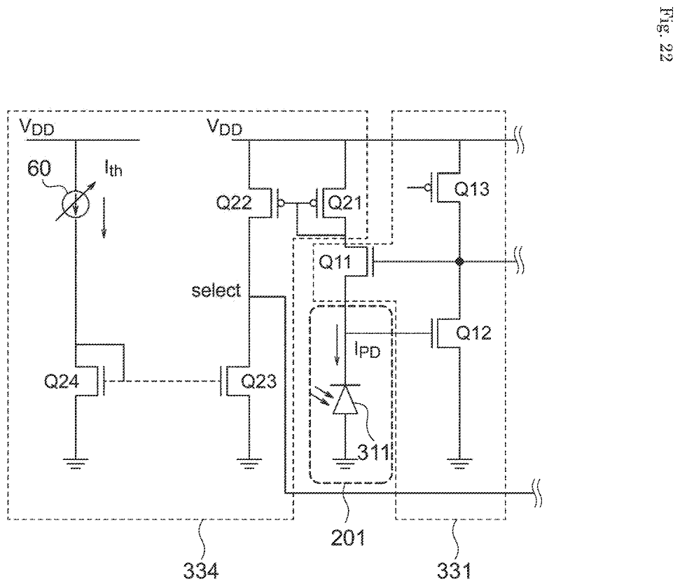

FIG. 22 is a diagram illustrating a third modified example of the chip layout. In this modified example, only the photoelectric conversion element 311 is disposed in the light receiving chip 201, and the address event detecting unit 33 (the current-voltage conversion circuit 331 to the threshold monitoring circuit 334) is disposed in the detection chip 202.

According to the chip layout illustrated in FIG. 22, the space of the light receiving chip 201 is larger than that of the second modified example. Thus, the light receiving area of the photoelectric conversion element 311 can be further widened.

According to this embodiment described above, similar to other embodiments, for each pixel 30, the optical current I_{PD} and the threshold current Iₜₕ are compared with each other. In addition, on the basis of a select signal representing a result of the comparison, the gain of the voltage Vout that is a target for determining presence/absence of an event occurrence is set. Thus, erroneous detection of event detection under a dark-time environment can be avoided.

### Sixth Embodiment

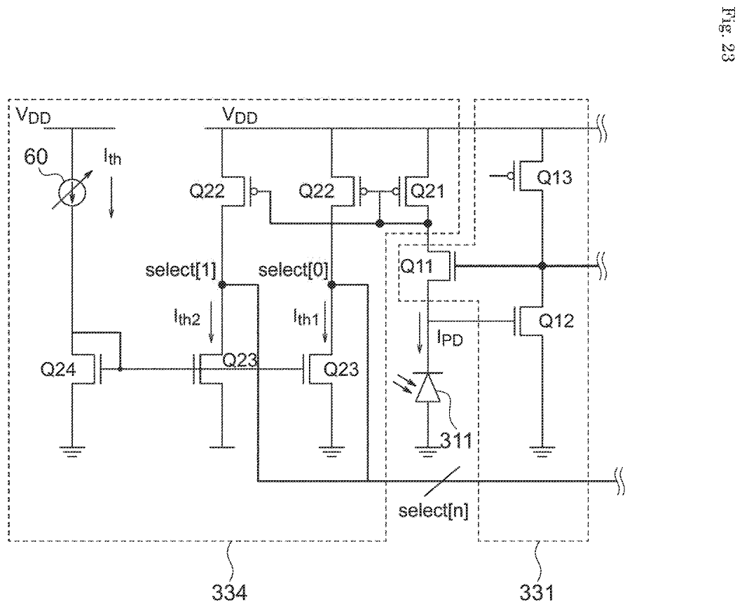

FIG. 23 is a circuit diagram of a major part of an event detecting unit of an imaging device according to a sixth embodiment. The same reference signs will be assigned to constituent elements that are similar to those of the address event detecting unit 33 (see FIG. 7) according to the first embodiment, and detailed description thereof will be omitted.

In a threshold monitoring circuit 334 according to this embodiment, a plurality of MOS transistors Q22 of the P-channel type and a plurality of MOS transistors Q23 of the N-channel type are disposed inside one pixel 30. The plurality of MOS transistors Q23 of the N-channel type have mutually-different ratios W/L between a channel width W and a channel length L of the gate. For this reason, in the threshold monitoring circuit 334, a plurality of threshold currents Iₜₕ₁ and Iₜₕ₂ are compared with an optical current I_{PD}, and an n-bit select signals representing results of the comparison is input to a first capacitance element 41 of a subtraction circuit 332.

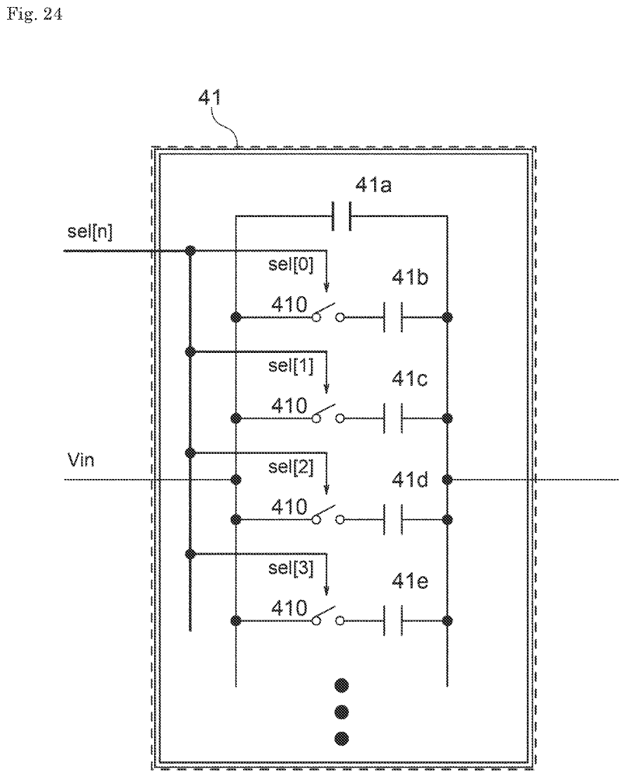

FIG. 24 is a diagram illustrating one configuration example of a first capacitance element 41 according to the sixth embodiment. In the first capacitance element 41 illustrated in FIG. 24, a plurality of capacitance elements 41a to 41e are connected in parallel with each other. In addition, a switching element 410 is connected to the capacitance element 41b to the capacitance element 41e in series. Each switching element 410 becomes on or off in correspondence with a level of a corresponding select signal.

In accordance with an increase of the optical current I_{PD}, the number of switching elements 410 that become on increases. As a result, the capacitance value C1 of the first capacitance element 41 also increases. In accordance with this, a gain of the voltage Vout of a subtraction circuit 332 becomes large. To the contrary, in accordance with a decrease in the optical current I_{PD}, the number of switching elements 410 decreases. As a result, the capacitance value C1 of the first capacitance element 41 also decreases. In accordance with this, the gain of the voltage Vout of the subtraction circuit 332 becomes small.

Also in this embodiment described above, the gain of the voltage Vout of the subtraction circuit 332 is adjusted in accordance with the value of the optical current I_{PD} flowing through the photoelectric conversion element 311. For this reason, erroneous detection of event detection under a dark-time environment can be avoided. Particularly, in this embodiment, the optical current I_{PD} is compared with a plurality of threshold currents, and the capacitance value C1 of the first capacitance element 41 changes for each comparison result. For this reason, the capacitance value C1 of the first capacitance element 41 can be finely adjusted, and thus a condition for event detection can be further optimized in accordance with an imaging environment.

### Seventh Embodiment

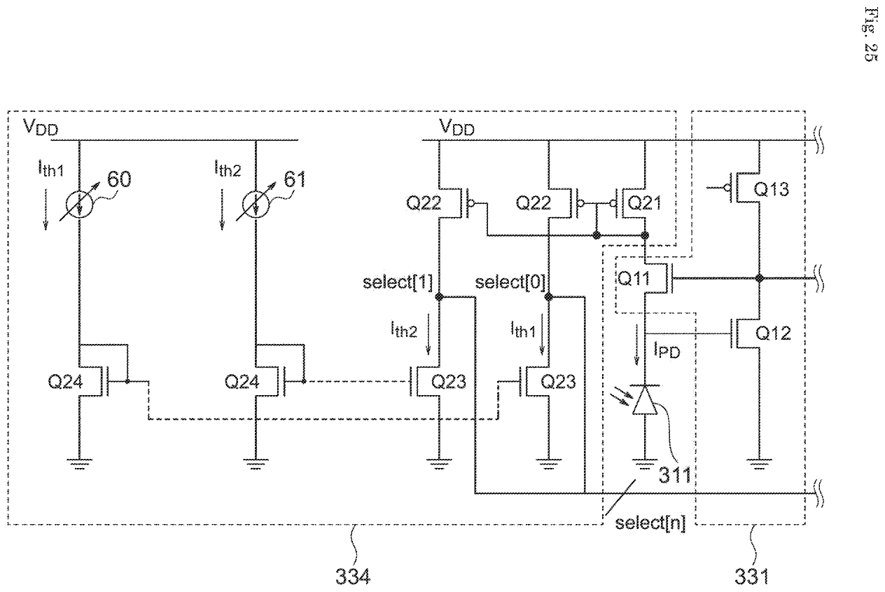

FIG. 25 is a circuit diagram of a major part of an event detecting unit of an imaging device according to a seventh embodiment. The same reference signs will be assigned to constituent elements that are similar to those of the address event detecting unit 33 (see FIG. 7) according to the first embodiment, and detailed description thereof will be omitted.

In a threshold monitoring circuit 334 according to this embodiment, a plurality of current sources 60 and 61 are provided. A MOS transistor Q24 of the N-channel type is connected to each of the current sources 60 and 61 in series. A threshold current Iₜₕ₁ is set in the current source 60, and a threshold current Iₜₕ₂ different from the threshold current Iₜₕ₁ is set in the current source 61.

In addition, in the threshold monitoring circuit 334 according to this embodiment, a plurality of MOS transistors Q22 of the P-channel type and a plurality of MOS transistors Q23 of the N-channel type are disposed inside one pixel 30. The plurality of MOS transistors Q23 of the N-channel type have the same ratio W/L between a channel width W and a channel length L.

Each MOS transistor Q23 of the N-channel type replicates a threshold current Iₜₕ₁ and a threshold current Iₜₕ₂ together with a corresponding MOS transistor Q24 of the N-channel type. For this reason, in the threshold monitoring circuit 334, a plurality of the threshold currents Iₜₕ₁, and Iₜₕ₂ are compared with the optical current I_{PD} and an n-bit select signal representing results of the comparison is input to the first capacitance element 41 of the subtraction circuit 332.

Similar to the sixth embodiment (see FIG. 24) described above, a plurality of capacitance elements 41a to 41e are connected to the first capacitance element 41 in parallel. In addition, switching elements 410 are connected to the capacitance elements 41b to 41e in series. Each switching element 410 becomes on or off in correspondence with a level of a corresponding select signal.

In accordance with an increase of the optical current I_{PD}, the number of switching elements 410 that become on increases. As a result, the capacitance value C1 of the first capacitance element 41 also increases. In accordance with this, the gain of the voltage Vout of the subtraction circuit 332 becomes large. To the contrary, in accordance with a decrease of the optical current I_{PD}, the number of switching elements 410 that become on decreases. As a result, the capacitance value C1 of the first capacitance element 41 decreases as well. In accordance with this, the gain of the voltage Vout of the subtraction circuit 332 becomes small.

Also in this embodiment described above, similar to the sixth embodiment, the optical current I_{PD} is compared with a plurality of threshold currents, and for each result of the comparison, the capacitance value C1 of the first capacitance element 41 changes. For this reason, the capacitance value C1 of the first capacitance element 41 can be finely adjusted, and thus a condition for event detection can be further optimized in accordance with an imaging environment. Particularly, in this embodiment, the threshold currents Iₜₕ₁ and Iₜₕ₂ can be set in a variable current source, and thus a degree of freedom of setting thresholds is high.

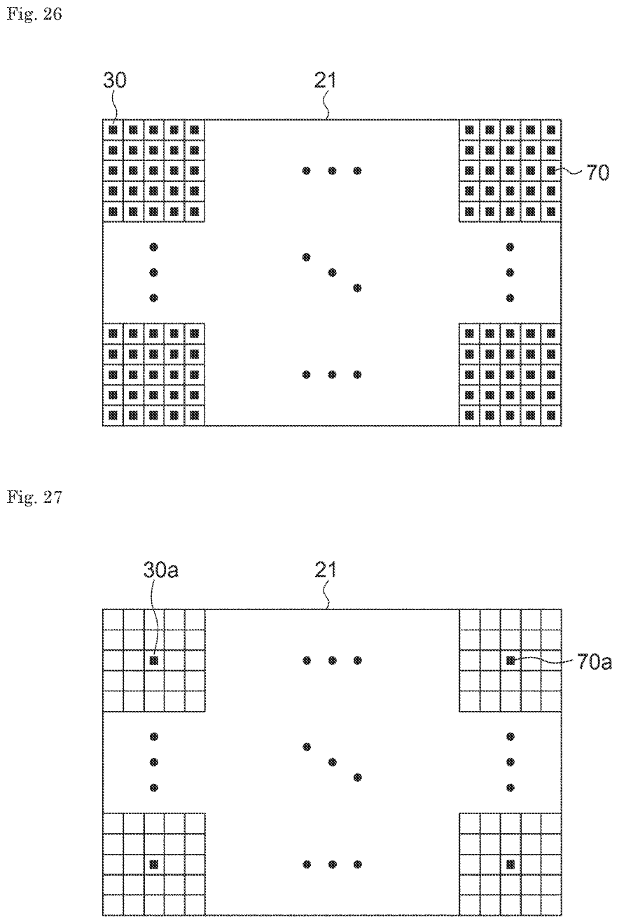

FIG. 26 is a diagram illustrating an arrangement form of the threshold monitoring circuit 334 described in each of the embodiments described above and a threshold variable circuit. The threshold variable circuit is a circuit having circuit elements that change in accordance with a select signal from the threshold monitoring circuit 334. In the first to third embodiments, the fifth embodiment, and the sixth embodiment, the subtraction circuit 332 corresponds to the threshold variable circuit. In addition, in the fourth embodiment, the subtraction circuit 332 and the event detecting circuit 333 correspond to a threshold variable circuit.

Each black square 70 illustrated in FIG. 26 represents a pixel 30 in which the threshold monitoring circuit 334 and the threshold variable circuit are disposed. In the arrangement form illustrated in FIG. 26, the threshold monitoring circuit 334 and the threshold variable circuit are disposed in all the pixels 30 of the pixel array unit 21.

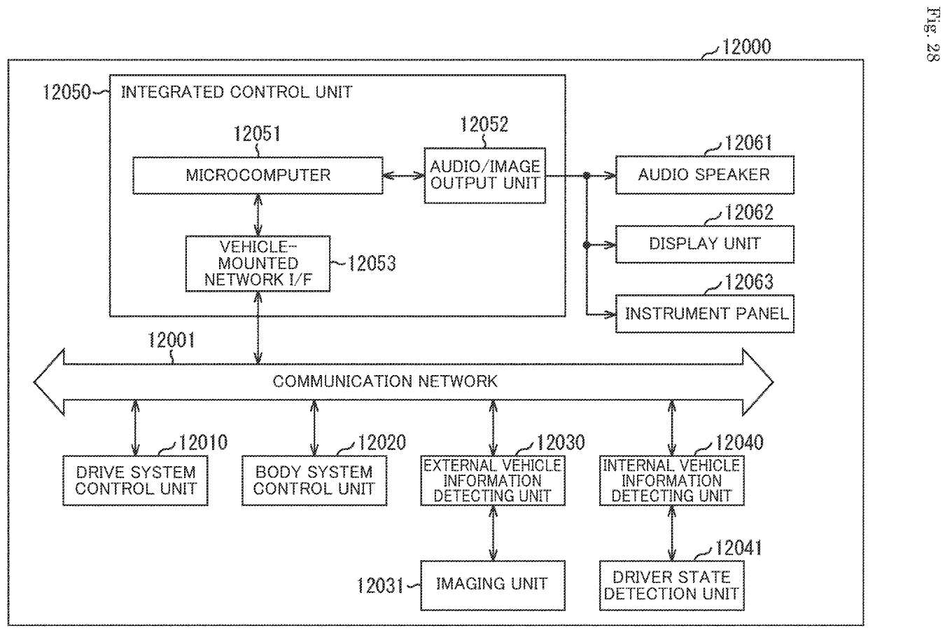

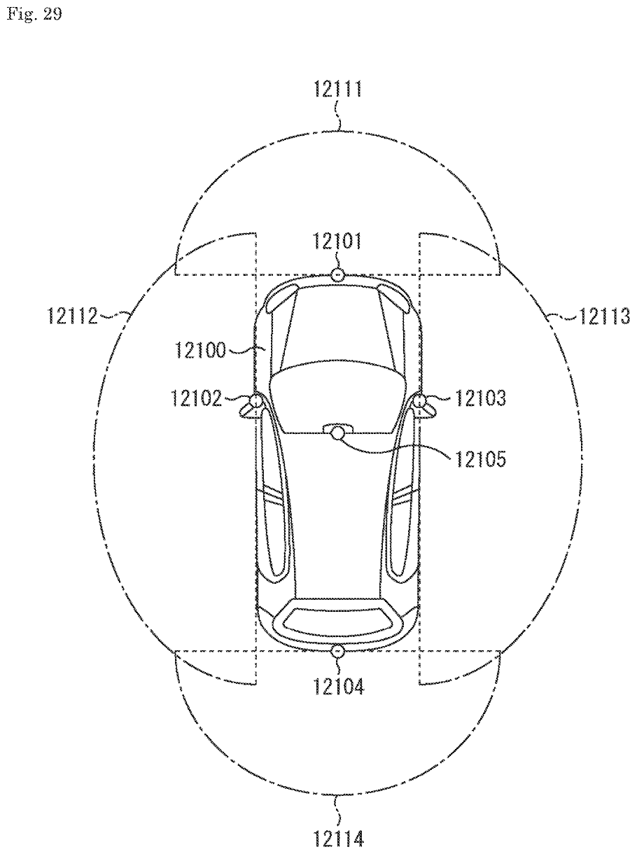

FIG. 27 is a diagram illustrating another arrangement form of the threshold monitoring circuit 334 described in each of the embodiments described above and the threshold variable circuit. Each black square 70a illustrated in FIG. 27 represents a pixel 30 in which the threshold monitoring circuit 334 is disposed. In this arrangement form, the threshold monitoring circuit 334 is disposed for each pixel group form from a plurality of pixels 30. On the other hand, the threshold variable circuit is disposed for each pixel 30. In this case, the threshold monitoring circuit 334 may monitor an optical current I_{PD} flowing through the photoelectric conversion element 311 of a pixel 30a positioned at the center in each pixel group. Alternatively, the threshold monitoring circuit 334 may monitor an average value of optical currents I_{PD} flowing through all the photoelectric conversion elements 311 inside all the pixels inside a corresponding pixel group.

As illustrated in FIG. 27, by sharing the threshold monitoring circuit 334 among a plurality of pixels, the mounting area of the imaging device 20 can be reduced.

### <Application to Mobile Object>

The technology of the present disclosure (the present technology) can be applied to various products. For example, the technique according to the present disclosure may be realized as a device mounted on any type of moving body such as an automobile, an electric automobile, a hybrid electric automobile, a motorcycle, a bicycle, a personal mobility device, an airplane, a drone, a ship, a robot, or the like.

FIG. 11 is a block diagram illustrating a schematic configuration example of a vehicle control system, which is an example of a moving body control system to which the technique according to the present disclosure can be applied.

A vehicle control system 12000 includes a plurality of electronic control units connected to each other via a communication network 12001. In an example shown in FIG. 11, the vehicle control system 12000 includes a drive system control unit 12010, a body system control unit 12020, an external vehicle information detecting unit 12030, an internal vehicle information detecting unit 12040, and an integrated control unit 12050. In addition, as functional components of the integrated control unit 12050, a microcomputer 12051, an audio/image output unit 12052, and a vehicle-mounted network I/F (interface) 12053 are shown in the drawing.

The drive system control unit 12010 controls an operation of an apparatus related to a drive system of a vehicle according to various programs. For example, the drive system control unit 12010 functions as a control device for a driving force generation device that generates a driving force of a vehicle such as an internal combustion engine, a driving motor, or the like, a driving force transmission mechanism that transmits a driving force to wheels, a steering mechanism that adjusts a steering angle of a vehicle, a braking device that generates a braking force of a vehicle, etc.

The body system control unit 12020 controls operations of various devices mounted in the vehicle body according to various programs. For example, the body system control unit 12020 functions as a control device of a keyless entry system, a smart key system, a power window device, or various lamps such as a headlamp, a back lamp, a brake lamp, a turn signal, and a fog lamp. In this case, radio waves transmitted from a portable device that substitutes for a key or signals of various switches may be input to the body system control unit 12020. The body system control unit 12020 receives inputs of the radio waves or signals and controls a door lock device, a power window device, and a lamp of the vehicle.

The external vehicle information detecting unit 12030 detects information on the outside of the vehicle having the vehicle control system 12000 mounted thereon. For example, an imaging unit 12031 is connected to the external vehicle information detecting unit 12030. The external vehicle information detecting unit 12030 causes the imaging unit 12031 to capture an image of the outside of the vehicle and receives the captured image. The external vehicle information detecting unit 12030 may perform object detection processing or distance detection processing for peoples, cars, obstacles, signs, and letters on the road on the basis of the received image.

The imaging unit 12031 is an optical sensor that receives light and outputs an electrical signal according to the amount of the received light. The imaging unit 12031 can also output the electrical signal as an image or distance measurement information. In addition, the light received by the imaging unit 12031 may be visible light or invisible light such as infrared light.

The internal vehicle information detecting unit 12040 detects information on the inside of the vehicle. For example, a driver state detection unit 12041 that detects a driver's state is connected to the internal vehicle information detecting unit 12040. The driver state detection unit 12041 includes, for example, a camera that captures an image of a driver, and the internal vehicle information detecting unit 12040 may calculate a degree of fatigue or concentration of the driver or may determine whether or not the driver is dozing on the basis of detection information input from the driver state detection unit 12041.

The microcomputer 12051 can calculate a control target value of the driving force generation apparatus, the steering mechanism, or the braking apparatus on the basis of information inside and outside the vehicle acquired by the external vehicle information detecting unit 12030 or the internal vehicle information detecting unit 12040, and output a control command to the drive system control unit 12010. For example, the microcomputer 12051 can perform cooperative control for the purpose of realizing functions of an ADAS (advanced driver assistance system) including vehicle collision avoidance, impact mitigation, following traveling based on an inter-vehicle distance, vehicle speed maintenance driving, vehicle collision warning, vehicle lane deviation warning, and the like.

Further, the microcomputer 12051 can perform cooperative control for the purpose of automated driving or the like in which autonomous travel is performed without depending on operations of the driver, by controlling the driving force generator, the steering mechanism, or the braking device and the like on the basis of information about the surroundings of the vehicle, the information being acquired by the external vehicle information detecting unit 12030 or the internal vehicle information detecting unit 12040.

In addition, the microcomputer 12051 can output a control command to the body system control unit 12030 based on the information outside the vehicle acquired by the external vehicle information detecting unit 12030. For example, the microcomputer 12051 can perform coordinated control for the purpose of antiglare such as switching a high beam to a low beam by controlling a headlamp according to a position of a preceding vehicle or an oncoming vehicle detected by the external vehicle information detecting unit 12030.

The audio/image output unit 12052 transmits an output signal of at least one of an audio and an image to an output device capable of notifying an occupant of the vehicle or the vehicle exterior of information visually or auditorily. In the example of FIG. 11, an audio speaker 12061, a display unit 12062, and an instrument panel 12063 are exemplified as output devices. The display unit 12062 may include, for example, at least one of an onboard display and a head-up display.

FIG. 12 is a diagram showing an example of an installation position of the imaging unit 12031.

In FIG. 12, the imaging unit 12031 includes imaging units 12101, 12102, 12103, 12104, and 12105.

The imaging units 12101, 12102, 12103, 12104, and 12105 are provided at positions such as a front nose, side-view mirrors, a rear bumper, a back door, and an upper portion of a windshield in a vehicle interior of the vehicle 12100, for example. The imaging unit 12101 provided on the front nose and the imaging unit 12105 provided in the upper portion of the windshield in the vehicle interior mainly acquire images in front of the vehicle 12100. The imaging units 12102 and 12103 provided in the side mirrors mainly acquire images on lateral sides of the vehicle 12100. The imaging unit 12104 included in the rear bumper or the back door mainly acquires an image of an area behind the vehicle 12100. The imaging unit 12105 included in the upper portion of the windshield inside the vehicle is mainly used for detection of a preceding vehicle, a pedestrian, an obstacle, a traffic signal, a traffic sign, a lane, or the like.

FIG. 12 illustrates an example of imaging ranges of the imaging units 12101 to 12104. An imaging range 12111 indicates an imaging range of the imaging unit 12101 provided at the front nose, imaging ranges 12112 and 12113 respectively indicate imaging ranges of the imaging units 12102 and 12103 provided at the side-view mirrors, and an imaging range 12114 indicates an imaging range of the imaging unit 12104 provided at the rear bumper or the back door. For example, a bird's-eye view image of the vehicle 12100 as viewed from above can be obtained by superimposing pieces of image data captured by the imaging units 12101 to 12104.

At least one of the imaging units 12101 to 12104 may have a function for obtaining distance information. For example, at least one of the imaging units 12101 to 12104 may be a stereo camera constituted by a plurality of imaging elements or may be an imaging element that has pixels for phase difference detection.

For example, the microcomputer 12051 can extract, particularly, a closest three-dimensional object on a path on which the vehicle 12100 is traveling, which is a three-dimensional object traveling at a predetermined speed (for example, 0 km/h or higher) in the substantially same direction as the vehicle 12100, as a preceding vehicle by acquiring a distance to each of three-dimensional objects in the imaging ranges 12111 to 12114 and a temporal change in the distance (a relative speed with respect to the vehicle 12100) on the basis of distance information obtained from the imaging units 12101 to 12104. Further, the microcomputer 12051 can set an inter-vehicle distance to be secured in advance in front of a preceding vehicle and can perform automated brake control (also including following stop control) or automated acceleration control (also including following start control). Thus, it is possible to perform cooperative control for the purpose of, for example, automated driving in which the vehicle travels in an automated manner without requiring the driver to perform operations.

For example, the microcomputer 12051 can classify and extract three-dimensional data regarding three-dimensional objects into two-wheeled vehicles, normal vehicles, large vehicles, pedestrians, and other three-dimensional objects such as electric poles based on distance information obtained from the imaging units 12101 to 12104 and can use the three-dimensional data to perform automated avoidance of obstacles. For example, the microcomputer 12051 differentiates surrounding obstacles of the vehicle 12100 into obstacles which can be viewed by the driver of the vehicle 12100 and obstacles which are difficult to view. Then, the microcomputer 12051 determines a collision risk indicating the degree of risk of collision with each obstacle, and when the collision risk is equal to or higher than a set value and there is a possibility of collision, an alarm is output to the driver through the audio speaker 12061 or the display unit 12062, forced deceleration or avoidance steering is performed through the drive system control unit 12010, and thus it is possible to perform driving support for collision avoidance.

At least one of the imaging units 12101 to 12104 may be an infrared camera that detects infrared rays. For example, the microcomputer 12051 can recognize a pedestrian by determining whether there is a pedestrian in the captured image of the imaging units 12101 to 12104. Such pedestrian recognition is performed by, for example, a procedure in which feature points in the captured images of the imaging units 12101 to 12104 as infrared cameras are extracted and a procedure in which pattern matching processing is performed on a series of feature points indicating an outline of an object to determine whether or not the object is a pedestrian. When the microcomputer 12051 determines that there is a pedestrian in the captured images of the imaging units 12101 to 12104 and the pedestrian is recognized, the audio/image output unit 12052 controls the display unit 12062 so that a square contour line for emphasis is superimposed and displayed with the recognized pedestrian. In addition, the audio/image output unit 12052 may control the display unit 12062 so that an icon indicating a pedestrian or the like is displayed at a desired position.

An example of the vehicle control system to which the technology according to the present disclosure can be applied has been described above. The technique according to the present disclosure may be applied to the imaging unit 12031 and the like among the above-described configurations. More specifically, the imaging devices according to the first to sixth embodiments can be applied to the imaging unit 12031. By applying the technology according to the present disclosure, a captured image in which erroneous detection is reduced can be acquired, and thus the image quality can be improved.

The present technique can also take on the following configurations.

(1) An imaging device including: a photoelectric conversion element configured to generate an optical current acquired by photoelectrically converting incident light; a current-voltage conversion circuit configured to convert the optical current into a voltage signal; a threshold monitoring circuit configured to monitor the optical current; a plurality of capacitance elements including a variable capacitance element of which a capacitance value changes on the basis of a monitoring result of the threshold monitoring circuit; and an event detecting circuit configured to detect a luminance change of the incident light on the basis of a result of comparison between an amplified voltage acquired by amplifying the voltage signal on the basis of a capacitance ratio of the plurality of capacitance elements and a threshold voltage.

(2) The imaging device described in (1), in which the threshold monitoring circuit includes: a current source configured to set a threshold current; a first current mirror circuit configured to replicate the optical current; and a second current mirror circuit configured to replicate the threshold current.

(3) The imaging device described in (2), in which the plurality of capacitance elements include a first capacitance element that is the variable capacitance element and a second capacitance element of which a capacitance value is smaller than that of the first capacitance element, a first capacitance value of the first capacitance element decreases in a case in which the optical current is smaller than the threshold current, and the first capacitance value increases in a case in which the optical current is equal to or larger than the threshold current.

(4) The imaging device described in (2), in which the plurality of capacitance elements include a first capacitance element of which a capacitance value is larger than that of a second capacitance element and the second capacitance element that is the variable capacitance element, a second capacitance value of the second capacitance element increases in a case in which the optical current is smaller than the threshold current, and the second capacitance value decreases in a case in which the optical current is equal to or larger than the threshold current.

(5) The imaging device described in (2), in which the plurality of capacitance elements include a first capacitance element that is the variable capacitance element and a second capacitance element, a first capacitance value of the first capacitance element and a second capacitance value of the second capacitance element are changed such that a capacitance ratio between the first capacitance element and the second capacitance element becomes small in a case in which the optical current is smaller than the threshold current, and the first capacitance value and the second capacitance value are changed such that the capacitance ratio becomes large in a case in which the optical current is equal to or larger than the threshold current.

(6) The imaging device described in (2), in which the event detecting circuit includes a switching circuit performing switching of the threshold voltage in accordance with a result of comparison between the optical current and the threshold current.

(7) The imaging device described in (2), in which the photoelectric conversion element, the current-voltage conversion circuit, the plurality of capacitance elements, and the event detecting circuit are disposed inside a pixel, and the first current mirror circuit and a part of the second current mirror circuit in the threshold monitoring circuit are disposed inside the pixel, and the current source and a remaining part of the second current mirror circuit are disposed outside the pixel.

(8) The imaging device described in (7), in which the entire threshold monitoring circuit is disposed in a first substrate that is the same as that of the photoelectric conversion element, the current-voltage conversion circuit, the plurality of capacitance elements, and the event detecting circuit.

(9) The imaging device described in (7), in which a part of the second current mirror circuit is disposed in a first substrate that is the same as that of the photoelectric conversion element, the current-voltage conversion circuit, the plurality of capacitance elements, and the event detecting circuit, and the current source and a remaining part of the second current mirror circuit are disposed in a second substrate stacked on the first substrate.

(10) The imaging device described in (7), in which the photoelectric conversion element and a part of the current-voltage conversion circuit are disposed in a first substrate, and a remaining part of the current-voltage conversion circuit, the plurality of capacitance elements, the event detecting circuit, and the threshold monitoring circuit are disposed in a second substrate stacked on the first substrate.

(11) The imaging device described in (7), in which the photoelectric conversion element is disposed in a first substrate, and the current-voltage conversion circuit, the plurality of elements, the event detecting circuit, and the threshold monitoring circuit are disposed in a second substrate stacked on the first substrate.

(12) The imaging device described in any one of (2) to (11), in which the first current mirror circuit includes a first MOS transistor of a P-channel type and a plurality of second MOS transistors of the P-channel type connected to the first MOS transistor of the P-channel type in parallel, the second current mirror circuit includes a plurality of first MOS transistors of an N-channel type connected to each of the plurality of second MOS transistors of the P-channel type in series and a second MOS transistor of the N-channel type connected to the current source in series, and the plurality of first MOS transistors of the N-channel type have mutually-different ratios of channel widths and channel lengths of gates.

(13) The imaging device described in any one of (2) to (11), in which the first current mirror circuit includes a first MOS transistor of a P-channel type and a plurality of second MOS transistors of the P-channel type connected to the first MOS transistors of the P-channel type in parallel, and the second current mirror circuit includes a plurality of first MOS transistors of an N-channel type connected to each of the plurality of second MOS transistors of the P-channel type in series and a plurality of second MOS transistors of the N-channel type connected to a plurality of current sources of which threshold currents are different from each other in series.

(14) The imaging device described in any one of (1) to (13), in which the variable capacitance element includes a plurality of capacitance elements connected with each other in parallel and at least one or more switching elements connected to other capacitance elements except for one capacitance element among the plurality of capacitance elements in series, and the switching element switches on and off in accordance with a monitoring result of the threshold monitoring circuit.

(15) The imaging device described in (14), in which the switching element includes a third MOS transistor of the P-channel type, a third MOS transistor of the N-channel type connected to the third MOS transistors of the P-channel type in parallel, and an inverter element connected between a gate of the third MOS transistor of the P-channel type and a gate of the third MOS transistor of the N-channel type.

(16) The imaging device described in any one of (1) to (15), further including a pixel array unit in which a plurality of pixels are arranged in a matrix shape, in which the threshold monitoring circuit is disposed in all the pixels of the pixel array unit.

(17) The imaging device described in any one of (1) to (15), in which the threshold monitoring circuit is disposed in a specific pixel in a pixel group formed from a plurality of pixels.

(18) An electronic apparatus including an imaging device including: a photoelectric conversion element configured to generate an optical current acquired by photoelectrically converting incident light; a current-voltage conversion circuit configured to convert the optical current into a voltage signal; a threshold monitoring circuit configured to monitor the optical current; a plurality of capacitance elements including a variable capacitance element of which a capacitance value changes on the basis of a monitoring result of the threshold monitoring circuit; and an event detecting circuit configured to detect a luminance change of the incident light on the basis of a result of comparison between an amplified voltage acquired by amplifying the voltage signal on the basis of a capacitance ratio of the plurality of capacitance elements and a threshold voltage.

(19) An imaging method including: generating an optical current acquired by photoelectrically converting incident light; converting the optical current into a voltage signal; monitoring the optical current; setting a capacitance value of a variable capacitance element on the basis of a monitoring result of the optical current; comparing an amplified voltage acquired by amplifying the voltage signal with a threshold voltage on the basis of a capacitance ratio of a plurality of capacitance elements including the variable capacitance element; and detecting a luminance change of the incident light on the basis of a result of comparison between the amplified voltage and the threshold voltage.

### REFERENCE SIGNS LIST

20 Imaging device
21 Pixel array unit
30 Pixel
41 First capacitance element
42 Second capacitance element
60, 61 Current source
201 Light receiving chip
202 Detection chip
311 Photoelectric conversion element
331 Current-voltage conversion circuit
333 Event detecting circuit
333a First switching circuit
333b Second switching circuit
410 Switching element
411 Inverter element
Q21 First MOS transistor of P-channel type
Q22 Second MOS transistor of P-channel type
Q23 First MOS transistor of N-channel type
Q24 Second MOS transistor of N-channel type
Q41 Third MOS transistor of P-channel type
Q42 Third MOS transistor of N-channel type

1. An imaging device comprising:
a photoelectric conversion element configured to generate an optical current acquired by photoelectrically converting incident light;
a current-voltage conversion circuit configured to convert the optical current into a voltage signal;
a threshold monitoring circuit configured to monitor the optical current;
a plurality of capacitance elements including a variable capacitance element of which a capacitance value changes on the basis of a monitoring result of the threshold monitoring circuit; and
an event detecting circuit configured to detect a luminance change of the incident light on the basis of a result of comparison between an amplified voltage acquired by amplifying the voltage signal on the basis of a capacitance ratio of the plurality of capacitance elements and a threshold voltage.

2. The imaging device according to claim 1, wherein the threshold monitoring circuit includes:
a current source configured to set a threshold current;
a first current mirror circuit configured to replicate the optical current; and
a second current mirror circuit configured to replicate the threshold current.

3. The imaging device according to claim 2,
wherein the plurality of capacitance elements include a first capacitance element that is the variable capacitance element and a second capacitance element of which a capacitance value is smaller than that of the first capacitance element,
wherein a first capacitance value of the first capacitance element decreases in a case in which the optical current is smaller than the threshold current, and
wherein the first capacitance value increases in a case in which the optical current is equal to or larger than the threshold current.

4. The imaging device according to claim 2,
wherein the plurality of capacitance elements include a first capacitance element of which a capacitance value is larger than that of a second capacitance element and the second capacitance element that is the variable capacitance element,
wherein a second capacitance value of the second capacitance element increases in a case in which the optical current is smaller than the threshold current, and
wherein the second capacitance value decreases in a case in which the optical current is equal to or larger than the threshold current.

5. The imaging device according to claim 2,
wherein the plurality of capacitance elements include a first capacitance element that is the variable capacitance element and a second capacitance element,
wherein a first capacitance value of the first capacitance element and a second capacitance value of the second capacitance element are changed such that a capacitance ratio between the first capacitance element and the second capacitance element becomes small in a case in which the optical current is smaller than the threshold current, and
wherein the first capacitance value and the second capacitance value are changed such that the capacitance ratio becomes large in a case in which the optical current is equal to or larger than the threshold current.

6. The imaging device according to claim 2, wherein the event detecting circuit includes a switching circuit performing switching of the threshold voltage in accordance with a result of comparison between the optical current and the threshold current.

7. The imaging device according to claim 2,
wherein the photoelectric conversion element, the current-voltage conversion circuit, the plurality of capacitance elements, and the event detecting circuit are disposed inside a pixel, and
wherein the first current mirror circuit and a part of the second current mirror circuit in the threshold monitoring circuit are disposed inside the pixel, and the current source and a remaining part of the second current mirror circuit are disposed outside the pixel.

8. The imaging device according to claim 7, wherein the entire threshold monitoring circuit is disposed in a first substrate that is the same as that of the photoelectric conversion element, the current-voltage conversion circuit, the plurality of capacitance elements, and the event detecting circuit.

9. The imaging device according to claim 7,
wherein a part of the second current mirror circuit is disposed in a first substrate that is the same as that of the photoelectric conversion element, the current-voltage conversion circuit, the plurality of capacitance elements, and the event detecting circuit, and
wherein the current source and a remaining part of the second current mirror circuit are disposed in a second substrate stacked on the first substrate.

10. The imaging device according to claim 7,
wherein the photoelectric conversion element and a part of the current-voltage conversion circuit are disposed in a first substrate, and
wherein a remaining part of the current-voltage conversion circuit, the plurality of capacitance elements, the event detecting circuit, and the threshold monitoring circuit are disposed in a second substrate stacked on the first substrate.

11. The imaging device according to claim 7,
wherein the photoelectric conversion element is disposed in a first substrate, and
wherein the current-voltage conversion circuit, the plurality of elements, the event detecting circuit, and the threshold monitoring circuit are disposed in a second substrate stacked on the first substrate.

12. The imaging device according to claim 2,
wherein the first current mirror circuit includes a first MOS transistor of a P-channel type and a plurality of second MOS transistors of the P-channel type connected to the first MOS transistor of the P-channel type in parallel,
wherein the second current mirror circuit includes a plurality of first MOS transistors of an N-channel type connected to each of the plurality of second MOS transistors of the P-channel type in series and a second MOS transistor of the N-channel type connected to the current source in series, and
wherein the plurality of first MOS transistors of the N-channel type have mutually different ratios of channel widths and channel lengths of gates.

13. The imaging device according to claim 2,
wherein the first current mirror circuit includes a first MOS transistor of a P-channel type and a plurality of second MOS transistors of the P-channel type connected to the first MOS transistors of the P-channel type in parallel, and
wherein the second current mirror circuit includes a plurality of first MOS transistors of an N-channel type connected to each of the plurality of second MOS transistors of the P-channel type in series and a plurality of second MOS transistors of the N-channel type connected to a plurality of current sources of which threshold currents are different from each other in series.

14. The imaging device according to claim 1,
wherein the variable capacitance element includes a plurality of capacitance elements connected with each other in parallel and at least one or more switching elements connected to other capacitance elements except for one capacitance element among the plurality of capacitance elements in series, and
wherein the switching element switches on and off in accordance with a monitoring result of the threshold monitoring circuit.

15. The imaging device according to claim 14, wherein the switching element includes a third MOS transistor of the P-channel type, a third MOS transistor of the N-channel type connected to the third MOS transistors of the P-channel type in parallel, and an inverter element connected between a gate of the third MOS transistor of the P-channel type and a gate of the third MOS transistor of the N-channel type.

16. The imaging device according to claim 1, further comprising a pixel array unit in which a plurality of pixels are arranged in a matrix shape,
wherein the threshold monitoring circuit is disposed in all the pixels of the pixel array unit.

17. The imaging device according to claim 1, wherein the threshold monitoring circuit is disposed in a specific pixel in a pixel group formed from a plurality of pixels.

18. An electronic apparatus comprising an imaging device including: a photoelectric conversion element configured to generate an optical current acquired by photoelectrically converting incident light; a current-voltage conversion circuit configured to convert the optical current into a voltage signal; a threshold monitoring circuit configured to monitor the optical current; a plurality of capacitance elements including a variable capacitance element of which a capacitance value changes on the basis of a monitoring result of the threshold monitoring circuit; and an event detecting circuit configured to detect a luminance change of the incident light on the basis of a result of comparison between an amplified voltage acquired by amplifying the voltage signal on the basis of a capacitance ratio of the plurality of capacitance elements and a threshold voltage.

19. An imaging method comprising:
generating an optical current acquired by photoelectrically converting incident light;
converting the optical current into a voltage signal;
monitoring the optical current;
setting a capacitance value of a variable capacitance element on the basis of a monitoring result of the optical current;
comparing an amplified voltage acquired by amplifying the voltage signal with a threshold voltage on the basis of a capacitance ratio of a plurality of capacitance elements including the variable capacitance element; and
detecting a luminance change of the incident light on the basis of a result of comparison between the amplified voltage and the threshold voltage.
